(19) United States
(12) Patent Application Publication
(10) Pub. No.: US 2025/0100005 A1
(43) Pub. Date: Mar. 27, 2025

(54) ARTIFICIAL TURF WITH TRACTION CONTROL AGENT

(71) Applicant: Polytex Sportbelage Produktions-GmbH, Grefrath (DE)

(72) Inventors: Dario GROCHLA, Bochum (DE); Stephan SICK, Baden-Baden (DE); Sven HAMANN, Muehlheim (DE); Thorsten VAN DEN BERG, Essen (DE)

(73) Assignee: Polytex Sportbelage Produktions-GmbH, Grefrath (DE)

(21) Appl. No.: 18/941,425

(22) Filed: Nov. 8, 2024

Related U.S. Application Data
(63) Continuation of application No. 18/861,958, filed on Jan. 1, 0001.
Application No. 18/861,958 is a continuation of application No. 18/489,393, filed on Oct. 18, 2023.
Application No. 18/489,393 is a continuation of application No. 18/480,089, filed on Oct. 3, 2023.

(30) Foreign Application Priority Data
Sep. 21, 2023 (EP) 23198797.5
Sep. 21, 2023 (EP) 23198798.3
Jul. 12, 2024 (WO) PCT/EP2024/069927
Jul. 12, 2024 (WO) PCT/EP2024/069928

(51) Int. Cl. B05C 1/08; E01C 13/08

(52) U.S. Cl. CPC B05C 1/0808; B05C 1/0821; B05C 1/0826; E01C 13/08

(57) ABSTRACT

A method of manufacturing an artificial turf provides for moving a carrier mesh through an air gap formed between a first electrode and a second electrode of a dielectric barrier discharge device, applying a dielectric barrier discharge to a backside of the carrier mesh for plasma-based activation of the backside, and applying a backing layer to the plasma-activated backside of the carrier mesh for providing the artificial turf.

### CROSS-REFERENCE TO RELATED APPLICATIONS

This application is a continuation of U.S. application Ser. No. 18/861,958, filed Oct. 31, 2024 which is a national phase under 35 U.S.C. § 371 of PCT International Application No. PCT/EP2024/076210 which has an International filing date of Sep. 19, 2024, which claims priority to International Application No. PCT/EP2024/069928 which has an International filing date of Jul. 12, 2024, and International Application No. PCT/EP2024/069927 which has an International filing date of Jul. 12, 2024, and European Application No. 23198798.3 filed Sep. 21, 2023, and European Application No. 23198797.5 filed Sep. 21, 2023, and U.S. application Ser. No. 18/489,393 filed Oct. 18, 2023, and U.S. application Ser. No. 18/480,089 filed Oct. 3, 2024, the entire contents of each of which are hereby incorporated by reference.

### FIELD OF THE INVENTION

Certain embodiments of the invention relate to the field of artificial turfs. More specifically, certain embodiments of the invention relate to methods of manufacturing an artificial turf and artificial turf products.

### BACKGROUND OF THE INVENTION

Artificial turf or artificial grass is surface that is made up of fibers which is used to replace grass. The structure of the artificial turf is designed such that the artificial turf has an appearance which resembles grass. Typically, artificial turf is used as a surface for sports such as soccer, American football, rugby, tennis, golf, for playing fields, or for exercise fields. Furthermore, artificial turf is frequently used for landscaping applications.

An advantage of using artificial turf is that it eliminates the need to care for a grass playing or landscaping surface, such as regular mowing, scarifying, fertilizing and watering. Watering can be difficult due to regional restrictions for water usage. In some climatic zones, regrowing grass for forming a closed grass cover is slow compared to the damage incurred by natural grass surfaces from playing and/or exercising on the field. Artificial turf fields, though they do not require similar attention and effort to be maintained, have lifetimes that are limited in part by the wear-and tear of normal use, and in part by the effects of cyclic seasonal changes (e.g., heat, moisture, freeze/thaw, air-born pollutants, etc.). For example, artificial turfs typically exhibit at least some type of wear after about 5-15 years. Mechanical damage from use and exposure to UV radiation, thermal cycling, interactions with chemicals and various environmental conditions may generate significant wear on artificial turf.

It is therefore beneficial to provide an artificial turf, and a method of manufacture, the can better tolerate the constant stresses imposed from use and exposure to the elements, and which can increase the useful lifespan of an artificial turf.

U.S. Pat. No. 7,026,031 B2 (Holeschovsky et al.), published Apr. 11, 2006, discloses a corona discharge process. Corona discharge processes use, as is conventionally known, only one electrode, whereby the electrode is not surrounded by a dielectric.

### BRIEF SUMMARY OF THE INVENTION

Various embodiments provide a method for manufacturing an artificial turf, an artificial turf obtainable according to the method, and an artificial turf, as described by the subject matter of the independent claims. Advantageous embodiments are described in the dependent claims. Embodiments of the present invention can be freely combined with each other if they are not mutually exclusive.

In one aspect, a method of manufacturing an artificial turf includes moving a carrier mesh through an air gap formed between a first electrode and a second electrode of a dielectric barrier discharge device, where the carrier mesh includes a backside, and where the carrier mesh includes fibers integrated such that a portion of the fibers are exposed on the backside, applying a dielectric barrier discharge to the backside of the carrier mesh for plasma activating or plasma-based activation of the backside, and applying a backing layer to the plasma-activated backside of the carrier mesh for providing the artificial turf.

For example, applying a dielectric barrier discharge to the backside of the carrier mesh for plasma activating or plasma-based activation of the backside may comprise applying the dielectric barrier discharge to the backside of the carrier mesh and to the portions of at least some of the fibers protruding to the backside of the carrier mesh (and forming, for example, tuft bundles or tuft rows).

Advantageously, applying a dielectric barrier discharge to the backside of the carrier mesh for plasma activating or plasma-based activation of the backside, and then applying a backing layer to the plasma-activated backside of the carrier mesh, provides an artificial turf having improved binding between the backside of the mesh and the backing layer, and moreover, improved binding between the fibers integrated into the mesh and the backing layer, in comparison to the binding between backing layer and fibers integrated into a mesh whose backside is not plasma-activated. The binding forces between the fibers, which are often made of an apolar polyolefin such as polyethylene, and the—typically polar—backing which can be made, e.g., from polyurethane, is often weak. By applying the dielectric barrier discharge to the backside of the carrier mesh and on fiber portions protruding to the backside will significantly increase the strength with which the fibers are integrated into the carrier mesh.

According to some embodiments, the carrier mesh includes fibers integrated such that a portion of the fibers are exposed on the backside. The carrier mesh also includes a front side. The first electrode is adjacent to the backside. The second electrode is adjacent to the front side. The method further comprises compressing the fibers exposed on the frontside. In particular the fibers exposed on the frontside may be compressed against the second electrode and within the air gap of the dielectric barrier discharge. The dielectric barrier discharge forms within the air gap between the two electrodes.

The effect of compressing the fibers exposed on the front side against the second electrode is to cover the second electrode and also to reduce the amount of air between the second electrode and the front side of the carrier mesh. This prevents or reduces plasma from being formed in this space. This may have the effect of reducing the effect of the dielectric barrier discharge on the fibers which are exposed on the front side. A larger portion of the power used for generating the dielectric barrier discharge is then used for modifying the portion of the fibers exposed on the backside. This may lead to better adhesion between the fibers on the backside and the carrier mesh.

If the artificial turf is manufactured using a conveyor unit, the conveyor unit may be configured such that the front side of the carrier mesh rests on the second electrode and compresses the fibers exposed on the front side.

The compression of the fibers exposed on the front side may be performed mechanically using various means. For example, tensioning structures may be used to pull or compress the carrier mesh against the second electrode. Other mechanical means, such as compressed air may assist in pushing the carrier mesh against the second electrode.

According to some embodiments, the second electrode or second electrode portions comprises a dielectric coating or dielectric layer. Objects or items adjacent to the second electrode or second electrode portions may then be interpreted as being in contact with or being adjacent to the dielectric coating or dielectric layer.

According to some embodiments, the conveyor unit is configured to mechanically compress the fibers exposed on the front side within the air gap against the second electrode. As was mentioned above, this may prevent or reduce the amount of plasma formed between the front side of the carrier mesh and the second electrode. Another advantage of mechanically compressing this is that the artificial turf requires less space. The distance between the first electrode and the second electrode may in some instances therefore be able to be reduced. This may lead to a larger electric field between the backside of the carrier mesh and the first electrode. This may result in a higher ionization and therefore more plasma activation of the fibers that are exposed on the backside.

According to some embodiments, compressing the fibers exposed on the front side reduces a pile height of the fibers. This means that the space between the second electrode and the front side of the carrier mesh is reduced. This reduces the amount of air and therefore reduces the chance or probability that there is plasma in this region as well as enabling the first and second electrodes to be positioned more closely together.

According to some embodiments, compressing the fibers reduces a volume of air within the air gap between the second electrode and the front side of the carrier mesh. This reduces the available volume in which a plasma discharge could form between the second electrode and the front side.

According to some embodiments, the system comprises a tensioning structure configured to pull the front side of the carrier mesh against the second electrode. The use of a tensioning structure may provide for a means of consistently controlling how much pressure or tension is used to compress the artificial turf against the second electrode. This may lead to greater consistency in the manufacture of the artificial turf.

According to some embodiments, the second electrode is cylindrical. The tensioning structure comprises a first tensioning roller and a second tensioning roller. The first tensioning roller and the second tensioning roller are mounted below the second electrode. The system is configured such that the carrier mesh is threaded between the first tensioning roller and the second electrode. The system is further configured such that the carrier mesh is threaded between the second electrode and the second tensioning roller. The use of these two tensioning rollers may provide for an effective means of implementing the tensioning structure. This may provide for better control of the force used to compress the fibers which extend beyond the front side of the carrier mesh.

According to some embodiments, the first electrode is formed from multiple first electrode portions. The multiple first electrode portions are electrically isolated and powered by separate power supplies. This may be advantageous because if there is arcing or instability in one of the dielectric barrier discharges it does not affect the other. The use of a separate power supply for each electrode portion may provide for better plasma activation of the fibers which are exposed on the backside.

The term electrode portion may be used interchangeably with electrode segment in that the first electrode is made up of one or more electrode portions or one or more electrode segments. The term electrode portion is used preferentially when the portions of the electrode have a separation such that they cause independent dielectric barrier discharges: The resulting dielectric barrier discharges are electrically isolated from each other. The electrode portions themselves may or may not be electrically isolated (powered by independent power supplies).

According to some embodiments, the first electrode portions extend parallel to an axis of the second cylindrical electrode. The multiple first electrode portions are configured to generate separate dielectric barrier discharges with the second electrode. The second electrode could for example be grounded and the two separate power supplies use this common ground.

According to some embodiments, the second electrode comprises two cylindrical second electrode portions. The use of multiple cylindrical second electrode portions may provide for a means of plasma treating the portion of the fibers exposed on the backside more than once. This may result in a higher pulling force in the manufactured artificial turf.

According to some embodiments, the two cylindrical electrode portions are parallel and aligned horizontally. The system comprises a tensioning structure configured to pull the front side of the carrier mesh against the two cylindrical second electrode portions. The tensioning structure is a tensioning roller mounted parallel to and between the two cylindrical second electrode portions. The tensioning roller is configured such that moving the tensioning roller in a downward direction increases compression of the fibers on the front side of the carrier mesh. This may provide for a means of process control in adjusting the plasma treatment of the artificial turf during manufacturing.

According to some embodiments, the first electrode comprises two first electrode portions. Each of the two first electrode portions are configured for forming the air gap with one of the two cylindrical second electrode portions for forming two separate dielectric barrier discharges. This may have the advantage of treating the backside of the carrier mesh and the fibers extending beyond the backside more than once resulting in better adhesion between the resulting backing layer to hold the carrier mesh and the turf fibers together.

According to some embodiments, the two first electrode portions are electrically isolated and powered by separate power supplies. As was mentioned above, the use of separate power supplies may enable the multiple dielectric barrier discharges to function independently. This may result in better or more uniform plasma treatment of the backside of the carrier mesh and the fibers exposed on the backside.

According to some embodiments, the two cylindrical second electrode portions are parallel and are aligned vertically. The first electrode comprises two cylindrical first electrode portions. The two cylindrical first electrode portions are parallel to the two cylindrical second electrode portions. Each of the two cylindrical first electrode portions are configured for forming the air gap with both of the two cylindrical second electrode portions for forming four separate dielectric barrier discharges. The tensioning structure comprises the two cylindrical first electrode portions. This example is particularly beneficial because it provides a means for not only tensioning the carrier mesh to compress the fibers exposed on the front side, but also to provide for four separate dielectric barrier discharges. This enables multiple application of the plasma without an increase in the amount of time to process the artificial turf. This may provide for artificial turf with an extremely large tuft removal force as well as providing for very economical manufacturing costs.

According to some embodiments, the two cylindrical first electrode portions are aligned horizontally. The two cylindrical first electrode portions are mounted between the two cylindrical second electrode portions. The two cylindrical first electrode portions have an adjustable gap. The two cylindrical first electrode portions are configured for adjusting compression of the fibers exposed on the front side by changing the adjustable gap. This may provide for an effective means of controlling the process of manufacturing the artificial turf.

According to some embodiments, the two cylindrical first electrode portions are electrically isolated and powered by separate power supplies. This may be beneficial because there are two dielectric barrier discharges which are related and another two dielectric barrier discharges which are powered by the same first electrode portion. By using separate power supplies not all four of the four separate dielectric barrier discharges are connected electrically. If there is instability or arcing within one of the dielectric barrier discharges, there will be other barrier discharges which are not affected.

In one embodiment, the first and second electrodes are elongated in a first direction, and the carrier mesh is moved in a second direction that is perpendicular to the first direction.

In another embodiment, the above-mentioned method is used for increasing the tuft bind and/or for increasing the homogeneity of tuft bind distribution in an artificial turf. The tuft bind and its distribution may be measured via the homogeneity of tuft withdrawal force.

In another embodiment, the carrier mesh includes a frontside. The first electrode is adjacent to the backside, the second electrode is adjacent to the frontside. For example, the front side may be the side from which the parts of the fibers that form the turf will protrude in basically upright direction once the artificial turf is installed at the use site and the backside may be the side where the backing is to be applied. Some portions of the fibers protrude to the backside of the carrier mesh, e.g., fiber portions comprised in tuft bundles and tuft rows, but the fiber portions exposed to the backside of the carrier mesh are shorter than the fiber portions protruding from the frontside and forming the turf.

The dielectric barrier discharge device comprises a dielectric. In particular, the second electrode of the dielectric barrier discharge device is at least partially enchased in the dielectric. Typically, the dielectric constant of the dielectric of the dielectric barrier discharge device is higher than the dielectric constant of the objects (greige good, carrier, etc.) transported through the gap for plasma-activation.

According to embodiments, the second electrode is at least partially encased in the dielectric. The dielectric extends at least in a direction towards the first electrode.

Advantageously, the application of the dielectric barrier discharge using a second electrode which is at least partially encased in a dielectric, and then applying a backing layer to the plasma-activated backside of the carrier mesh, provides an artificial turf having even more improved binding between the backside of the mesh and the backing layer, and moreover, even more improved binding between the fibers integrated into the mesh and the backing layer, in comparison to the binding between the backing layer and fibers integrated into a mesh whose backside is not plasma-activated.

In contrast to a corona discharge system, typically having only a single electrode, the dielectric barrier discharge (DBD) device of the present invention has at least two electrodes, at least one of which is at least encased in (i.e., at least partially surrounded by) a dielectric.

In case a corona discharge system uses two electrodes, the counter electrode is geometrically highly asymmetric with respect to the cathode and no dielectric barrier is used. The dielectric used in a dielectric barrier discharge device advantageously limits current flow and distributes the plasma discharge more uniformly over the backside of the carrier mesh, thereby enabling the formation of a more homogeneous distribution of covalent binding between the backside and the applied backing layer, resulting in an overall improvement in the strength of attachment between the backing layer and the fibers of the carrier mesh. In effect, the dielectric enables the plasma discharge (i.e., the bombardment of the mesh backside (surface) by high energy ions from the plasma formed in the air gap) to be more homogeneously distributed onto the mesh backside, thereby resulting in the formation of a more homogeneous distribution of covalent bonds with the backing layer, which is applied shortly thereafter to the backside is plasma-activated. This is particularly advantageous in the context of products having an uneven surface to be treated, such as the uneven backside surface of greige goods comprising tuft rows. Without the wish to be bound by any theory, applicant believes that the insulating properties of the tuft rows, and hence the irregularities they cause in the electric field in the air gap, are comparatively small compared to the impact of the dielectric surrounding the second electrode. Hence, the dielectric ensures that a homogeneous plasma-discharge can be achieved also on uneven surfaces such as the backside of greige good.

In a further advantageous aspect, much less energy is consumed than in other existing plasma activation approaches. Applicant has tested plasma jet nozzles and has observed that much more energy is needed for achieving a similar improvement of the tuft bind as with the DBD machine. Furthermore, the excess heat generated by the plasma jet nozzles result in a head-degradation of the polymer material of the carrier mesh. This problem can be avoided by using a DBD machine which generates much less heat and nevertheless achieves a significant improvement of tuft bind.

In another embodiment, the dielectric is composed of plastic material. In particular, the dielectric material may be a plastic that is hard and robust enough to be used to transport greige good in a production plant for artificial turf.

Preferably, the dielectric has a dielectric constant (relative permittivity) of at least 2.0, preferably higher, e.g., at least 2.2, or at least 2.5, or at least 3.0. In some examples, the dielectric has a dielectric constant between 2.0 and 6.0. In general, the higher the dielectric constant, the better a material functions as an insulator. For example, rubber has a very high dielectric constant, and so it may be used as the dielectric. For example, different types of rubber have dielectric constants between 2.0 and 4.0. According to one embodiment, rubber, in particular hard rubber, having a dielectric constant of about 2.8, may be used. Other types of material may also be used, e.g., nylon having a dielectric constant of 3.4 to more than 22.

In some embodiments, the thickness of the dielectric material covering/embedding the second electrode is at least 0.2 cm. For example, the thickness can be 0.2 cm to 10.0 cm, in particular 1 cm to 5 cm, preferably 2.0 cm to 3.0 cm.

In yet another embodiment, the second electrode is shaped as a cylinder with a circular or ellipsoid cross-section, coated with the dielectric material. The cylinder can be, for example, a hollow or solid cylinder. The second electrode may be a metal cylinder. The cylinder formed by the second electrode and the dielectric material coating the cylinder walls of the second electrode can be mounted rotatably in the plasma-activation machine.

In another embodiment the outer surface of a dielectric at least partially encases the second electrode. This may be beneficial because it may prevent arcing between the first electrode and the second electrode thereby enabling the formation of the dielectric barrier discharge.

In another embodiment the dielectric covers the second electrode to provide electrical isolation to form the dielectric barrier discharge. In a dielectric barrier discharge there is at least one dielectric layer that is positioned between the first electrode and the second electrode. This dielectric prevents unrestricted current from flowing between the first electrode and the second electrode. For example, if there were no dielectric and a large or high voltage were applied between the first electrode and the second electrode, then an arc could form between the first electrode and the second electrode. This would mean that there is a very intense plasma at the location of the arc and possibly no plasma anywhere else. The dielectric limits the current flowing between the first electrode and the second electrode to the displacement current. This has the effect of preventing individual arc discharges and causes a plasma to be more evenly distributed between the first electrode and the second electrode. This means that the plasma activation on the back side of the carrier mesh may be more uniform which leads to better bonding between the backing layer and the back side of the carrier mesh.

In another embodiment the second electrode comprises a curved surface that is symmetric about a cylindrical axis. For example, the second electrode may be a cylinder and the curved surface is the extrusion of a circle about the cylindrical axis. The dielectric covers at least the curved surface. The curved surface is used to form the air gap with the first electrode. By covering the curved surface the second electrode may be protected from individual arcs.

In another embodiment the carrier mesh is moved through the air gap perpendicular to the cylindrical axis. Moving the carrier mesh in this manner may facilitate moving the carrier mesh in a uniform motion using the curved surface.

The method further comprises rotating the second electrode about the cylindrical axis during transport of the carrier mesh through the air gap.

In another embodiment the first electrode is formed from at least one first electrode segment. The at least one first electrode segment is mounted above the curved surface and extends along the cylindrical axis to form at least a portion of the air gap parallel to the cylindrical axis. The electrode segments may, for example, be bars or bar shaped and extend parallel to the cylindrical axis. The electrode may be divided, as was mentioned above, into individual (possibly bar shaped) electrode segments. By mounting above, as used herein, encompasses mounting the first electrode segment such that a gravitational force would move it towards the curved surface. Dividing the electrode into multiple segments may be beneficial because the plasma can be formed individually between these electrode segments and the first electrode. This may result in a more uniform plasma being formed.

In some embodiments the individual electrode segments may be bar-shaped or have a surface that forms the first electrode that is bar-shaped and is then mounted parallel to the cylindrical axis. This may be beneficial because it may provide for an good way of assuring that the dielectric barrier discharge is formed uniformly in the air gap, which enables more uniform plasma treatment of the back side of the carrier mesh.

In another embodiment the first electrode is formed from at least one first electrode segment. The at least one electrode segment is mounted above the second electrode. In the previous embodiment the second electrode was cylindrical. However, it is not necessary that the second electrode be cylindrical. For example, the carrier mesh could be suspended above the second electrode and the second electrode could have, for example, a flat surface. In this case the second electrode would not form part of the mechanical structure used to support and move the carrier mesh.

In another embodiment, the at least one first electrode segment forms collectively at least one dielectric barrier discharge line across the width of the carrier mesh. This “discharge line” may be parallel to the cylindrical axis of the second electrode. For example, the dielectric barrier discharge may form one or more lines across the width of the carrier mesh. This may ensure that the carrier mesh is plasma treated uniformly.

In another embodiment, the at least one electrode segment is assisted by gravity to form the air gap. For example, the first electrode segment may be mounted above the second electrode and then the weight of gravity pulls the first electrode segment into proper position. In some examples the first electrode segment may be mounted such that it is able to freely pivot as the carrier mesh is moved. The carrier mesh has a back side and then a front side with tufts of artificial grass sticking out the front. This means that at certain times the position of the back side relative to the at least one first electrode segment may vary over time. By having the gravitational force move the at least first electrode segment into proper position, this may enable the dielectric barrier discharge to be formed using a variable spacing according to how the carrier mesh is moving through the dielectric barrier discharge device.

In another embodiment, the at least one electrode segment is mounted to an electrode segment-specific pivot arm (or multiple electrode segment-specific pivot arms) that rotates at least one first electrode segment into position to form the air gap. The electrode segment-specific pivot arm may be a pivot arm that supports one electrode segment. This means that the individual electrode segments may pivot individually. This may for example be beneficial in the case where the carrier mesh moves non-uniformly through the dielectric barrier discharge device. This may enable the particular electrode segment to adapt locally to the position of the carrier mesh.

In another embodiment, the gravitational force causes the at least one first electrode segment to contact the back side during application of the dielectric barrier discharge. This may be done using several different variants. In one variant the at least one first electrode segments are configured such that they contact the back side directly. In another example, there may be a spacer or roller element attached to or adjacent to the electrode segment such that it is held mechanically a certain spacing above the carrier mesh. However, in tests the dielectric barrier discharge is able to form satisfactorily when the at least one electrode segment was allowed to freely contact the surface of the backside of the carrier mesh.

In another embodiment, the at least one electrode segments are multiple first electrode segments. In this case the electrode is positively divided into multiple segments. For example, the multiple first electrode segments may be divided into 2-20 multiple first electrode segments. The benefit of having the multiple electrode segments is this may result in both mechanical and electrical adjustment of the dielectric barrier discharge locally. The carrier mesh is essentially a carpet with the pile being formed by the artificial turf fibers on the front side of the carpet. This means as it is moved there may be some variability in how the carrier mesh moves relative to the second electrode. Dividing the at least electrode segment into the multiple first electrode segments may enable the adjustment of the position of the first electrode segment mechanically to optimize the dielectric barrier discharge.

Another benefit is that the multiple first electrode segments may be powered independently in some examples. This may for example enable the discharge on a particular first electrode segment to be controlled independently. This may result in increases in the uniformity of the dielectric barrier discharge during plasma treatment of the back side of the carrier mesh.

In another embodiment the multiple first electrode segments are configured for independent motion to form the air gap. This may be beneficial because it may provide for a means of adjusting the mechanical position of individual first electrode segments to optimize them locally. This may result in better plasma treatment of the back side of the carrier mesh.

In another embodiment, the multiple first electrode segments are arranged to form multiple air gaps with the first electrode such that the back side is plasma-activated multiple times. Dielectric barrier discharges have a tendency to form local plasma discharges. Processing the back side of the carrier mesh with multiple plasma treatments may result in more uniform plasma activation of the back side of the carrier mesh.

The arrangement to perform multiple air gaps or to form multiple dielectric barrier discharges may be performed in several different ways. For example, if the second electrode is cylindrical or has a flat surface there may be several rows of first electrode segments such that as the carrier mesh moves past the second electrode each point on the back side of the carrier mesh moves through several different dielectric barrier discharges.

In another embodiment, the multiple first electrode segments are electrically isolated. This may have the benefit that the performance of a dielectric barrier discharge on one first electrode does not affect the other one electrically. This may enable a better distribution of the dielectric barrier discharge and therefore better plasma activation of the back side of the carrier mesh.

In another embodiment, the multiple first electrode segments are connected to independent power supplies. Supplying power to the individual first electrode segments independently may have the effect of providing for a more uniform dielectric barrier discharge. As was mentioned above before, the dielectric and the dielectric barrier discharge serves to form a type of capacitor that limits the direct flow of current between the first electrode and the second electrode. The current flowing between the two electrodes is therefore limited to the displacement current across the dielectric. To maintain a continuous or repeated dielectric barrier discharge, the power supplies are often times either pulsed high voltage power supply or use an alternating or radio frequency power supply.

In another embodiment, the method further comprises applying the dielectric barrier discharge to the back side of the carrier mesh multiple times. This may have the effect of providing for better or more uniform plasma activation of the back side of the carrier mesh. This may result in greater adhesion between the backing layer and the tufts of the artificial turf.

In another embodiment, the dielectric barrier discharge is applied to the back side of the carrier multiple times by using multiple dielectric barrier discharge devices. For example, the carrier mesh could be run over multiple second electrodes and their associated first electrode segments to provide the multiple plasma treatment to the back side.

In another embodiment, the dielectric barrier discharge is applied to the back side of the carrier multiple times by locally moving the carrier through the dielectric barrier discharge device in a reciprocating fashion. In web-based manufacturing systems the material or carpet is moved in a constant and in a linear fashion. This may still be maintained by only having the reciprocating motion locally. For example, before and after the dielectric barrier discharge device there may be some slack in the carrier mesh. For example, rollers may be used to hold the carrier mesh taught before and after the dielectric barrier discharge device and then the slack enables the carrier mesh to be moved reciprocating only locally through the dielectric barrier discharge. This may have the advantage of providing for a means of applying the dielectric barrier discharge multiple times without an increase in the number of power supplies and electrodes needed.

In some embodiments, the dielectric is in contact with the frontside of the carrier mesh, e.g., for transporting the carrier mesh with the fibers (the greige good) by a rotational movement of the second electrode with the dielectric material layer. The dielectric may be a hollow cylinder surrounding the cylindrical metal core that serves as the second electrode. Advantageously, a dielectric shaped as a hollow cylinder and in contact with the frontside of the carrier mesh has less surface area in contact with the frontside of the carrier mesh as compared to dielectrics of other shapes, thereby minimizing a build-up of static electrical charges on the carrier mesh and/or on the dielectric due to the relative motion between them as the carrier mesh moves through the air gap.

In some embodiments, the second electrode being at least partially encased in the dielectric is configured to be rotatable about its longitudinal axis. According to some embodiments, the second electrode is coupled to a motor configured to rotate the second electrode and the dielectric along the longitudinal axis, thereby moving the carrier mesh through the air gap formed between the first electrode and the second electrode. According to other embodiments, the second electrode is not coupled to a motor and is rather passively rotated by frictional forces with the greige good when the carrier mesh is moved by other actuators through the air gap.

Advantageously, causing the second electrode encased in the dielectric (which is in contact with the frontside of the carrier mesh) to rotate about its longitudinal axis essentially eliminates or reduces a build-up of static electrical charges on the carrier mesh and the dielectric, since there is no relative motion at the contact points between them as the carrier mesh moves through the air gap.

In one embodiment, applying the backing layer to the plasma-activated backside (and at least some of the fiber portions protruding to the backside, e.g., within tuft rows) includes applying the backing layer within a time period of less than two days, e.g., less than one day, e.g., less than 1 hour, e.g., less than 5 minutes after applying the dielectric barrier discharge to the backside of the carrier mesh. According to some embodiments, the artificial turf is manufactured in accordance with a roll-to-roll process and applying the backing layer to the plasma-activated backside includes performing the plasma activation step and performing the applying of the backing layer within the roll-to-roll process. “Roll-to-roll” means that a roll of greige good or a roll of carrier mesh is provided as input, which is unrolled, further processed (e.g., tufted (in the case of the carrier mesh), plasma-activated, subject to the application of the backing layer, heat-treated, and then rolled up to provide a roll of the product, i.e., artificial turf.

Advantageously, applying the backing layer within a predefined time period after applying the dielectric barrier discharge to the backside of the carrier mesh results in most, if not all, of the number of plasma-enhanced receptive sites created by the plasma discharge being still available for forming respective covalent bonds with the backing layer, when applied.

In one embodiment, the dielectric barrier discharge and the backing layer are applied as subsequent steps in a production line system.

Advantageously, applying processing steps in a production line system, such as in system of FIG. 1, or in a separate system that only includes the processing steps of applying the dielectric barrier discharge and applying the backing layer, reduces the cost and time for manufacturing an artificial turf, provides for a more efficient process, and simplifies the customization of new production line systems that may include any combination of the processing steps disclosed in the system embodiment of FIG. 1.

In other embodiments, the carrier mesh is moved through the air gap at a manually-adjustable and/or automatically-adjustable speed.

Advantageously, providing a manually-adjustable and/or automatically-adjustable speed results in a more efficient matching of the speed with other parameters of the system, such as rate of application of the backing layer mixture from the dispensing unit and/or power applied to the backside of the carrier mesh as a plasma discharge from the DBD device, for optimizing the number of covalent bonds between the backside of the carrier mesh and the backing layer.

According to embodiments, the second electrode is the anode and the first electrode is the cathode.

According to some embodiments, the first electrode is a single wire or a set of two or more wires. In case multiple wires are used, all wires preferably have approximately the same distance to the surface of the dielectric. Using multiple wires may have the advantage that the plasma is applied more homogeneously over a larger surface.

According to other embodiments, the first electrode is a conductive profile, e.g., a metal profile, e.g., a rod or bar or a profile having an L-shaped or T-shaped cross section, or a set of two or more of said profiles. Advantageously, this may increase the mechanical rigidity and stability of the first electrode and may ensure that the air gap has basically the same width over multiple meters, the typical width of an artificial turf roll.

According to some examples, the multiple wires or multiple profiles constituting the first electrode are placed and configured such that they are oriented in parallel to each other and have basically the same distance to the surface of the carrier mesh.

This may have the advantage of providing a particular strong and efficient plasma-activation of the backside of the carrier mesh and of at least some of the fiber portions protruding therefrom: applicant has observed that the strength of plasma-activation does not increase linearly with the applied voltage or power. Rather, a saturation is reached (see the small increase of tuft bind resulting from increasing the power from 500 Watt to 700 Watt as illustrated in FIG. 9). However, by using two or more first electrodes, a significant increase of the tuft bind can be achieved: Two simultaneously discharging electrodes are equivalent to a double treatment of the surface, which increases the probability of maximum surface activation.

According to some examples, the multiple wires or multiple profiles are oriented in parallel and/or have the same cross-sectional shape.

According to some examples, the first electrode and the second electrodes are oriented in parallel to each other and have approximately (+/−10%) the same length.

According to some examples, the multiple wires, rods or bars constituting the first electrode are galvanically decoupled from each other. For example, the multiple wires, rods or bars constituting the first electrode may all be coupled to the same electrical energy source or may each be coupled to a respective electrical energy source. The electrical energy source or sources are configured for the generation of a high voltage.

The galvanically decoupling of the multiple electrodes forming the first electrode (also referred to as the “multiple first electrodes”) may have the advantage that if one of these first electrodes discharges at least partially due to contact with a certain point of the surface of the carrier mesh, this does not lead to a significant discharge of the one or more other first electrode(s). In fact, the other first electrode(s) retains its (their) high voltage potential unchanged, so that even in the case of a short-term partial discharge of one of the two or more first electrodes as a result of the one first electrode locally contacting the backside of the carrier mesh, the other one continues to perform the plasma activation. This has the advantage that a particularly homogeneously distributed, large-area plasma activation can be achieved also in very uneven surfaces such as the backside of a carrier mesh comprising tuft rows. In general, it is advantageous to position the first electrode or first electrodes as close as possible to the surface of the carrier mesh in order to generate a very high voltage field there. However, in some use-case scenarios, contact between the first electrode and the surface of the carrier mesh should be avoided, as this leads to unwanted, local plasma discharges, which is disadvantageous because the local discharge causes a reduction of the applied voltage field and plasma activation is reduced or even interrupted for a short time along the entire length of the affected first electrode. However, due to the uneven nature of the carrier mesh with the tuft rows, occasional punctiform contact cannot be completely prevented. By using one or more additional first electrodes that are galvanically decoupled from each other, it is possible to ensure that even in the event of a local discharge of one of the electrodes, the other first electrodes still maintain their voltage field and plasma activation can take place there.

According to some examples, the galvanic decoupling can be achieved by using a dielectric barrier discharge machine having a discrete architecture. For example, each of the multiple first electrodes may be connected to a respective power source, e.g., a primary power source or a capacitor. Hence, the dielectric plasma discharge device may comprise multiple power sources, whereby each power source serves only one of the first electrodes for ensuring that the voltage field generated between the respective one of the first electrodes and the second electrode is not affected by a complete or partial discharge of another one of the first electrodes.

According to other embodiments, the same power source is used for the multiple first electrodes.

According to embodiments, the dielectric barrier discharge device is configured to generate a voltage field between the one or more first electrodes on the one hand and the second electrode on the other hand of at least 1 kV, in particular of at least 10 kV, in particular of at least 20 kV, e.g., of at least 30 kV, preferably of a voltage in the range of 30 kV to 40 kV.

The effect of a particularly homogeneous plasma-activation of the carrier mesh and, as a consequence, of a particularly homogenously distributed improvement of the tuft bind, can be inferred e.g., from the tuft bind standard deviations illustrated in FIGS. 9A and 9B.

In yet another embodiment, the dielectric barrier discharge is applied at an energy density of at least 0.1 J/cm², in particular of at least 0.3 J/cm², in particular of at least 0.5 J/cm², and in particular between 0.5 J cm² and 0.6 J/cm² to the backside of the carrier mesh. For backing layers applied to the backside between about 650-700 g/m², and with the carrier mesh having ¾ inch gauge fibers integrated with 180 stiches/m and a pile height of 60 mm, the applied energy density between 0.5 J cm² and 0.6 J/cm² advantageously results in an optimized binding between the fibers and the applied backing layer for a DBD device having one first electrode (i.e., further increases in the applied energy density do not result in any appreciable increases in binding).

In some other embodiments, the gap between the first electrode(s) and the second electrode is adjustable, e.g., is adjustable such that a gap between the outer surface of the dielectric at least partially enchasing the second electrode and the first electrode(s) is greater than 0 mm, in particular greater than 15 mm, in particular larger than 30 mm, in particular greater than 40 mm, in particular between 40 mm and 80 mm. According to embodiments, the gap is 35 mm to 55 mm thick. The outer surface of the dielectric is the surface of the dielectric facing towards the first electrode.

For example, the gap may be greater than 0 mm, in particular greater than 10 mm, e.g., greater than 20 mm, e.g., greater than 30 mm, e.g., greater than 40 mm, e.g., greater than 50 mm, in some cases even greater than 80 mm, e.g., 100 mm in width. According to some examples, the gap between the first electrode(s) and the second electrode is adjustable such that the gap between the outer surface of the dielectric at least partially enchasing the second electrode and the first electrode(s) is less than 100 mm, e.g., less than 80 mm, preferably less than 50 mm, e.g., less than 10 mm in width.

Without wishing to be bound by any theory, the applicant believes that the dielectric enchasing the second electrode makes it possible to design and use a plasma activation device which allows the width of the air gap between the surface of the dielectric and the first electrodes to be adjusted over a wide range, thereby allowing plasma activation even of greige goods which are several centimeters thick and have a very uneven surface. This is because the dielectric makes it possible to generate a stable high voltage field, high enough for effective plasma activation even when the distance between the two electrodes is large, while at the same time preventing strong discharges at individual points where the tuft rows or other protrusions may come into contact with the first electrodes.

According to some examples, the gap can be adjustable such that a distance between the backside of the carrier mesh and the first electrode(s) of less than 10 mm, preferably less than 5 mm is formed.

An adjustable distance allows for receiving different carrier meshes in the air gap of the DBD device having different widths and/or accommodating in the gap a single carrier mesh that has varying mesh widths (e.g., due to mesh manufacturing inconsistencies), and/or allows for efficient adjustment to accommodate for different ambient conditions, such as temperature and humidity, or different voltages applied to the first electrode. For example, the adjustment may be performed before or while performing the plasma-activation. To allow for a strong plasma-activation, the distance between the carrier mesh backside and the first electrodes(s) should be very small, e.g., smaller than 5 mm, e.g., only 1-3 mm, or even 0 mm. Hence, in some embodiments, the dielectric barrier discharge device may comprise a first electrode positioned such that the distance between the first electrode(s) and the surface of the backside of the carrier mesh and the fiber portions protruding therefrom is zero, meaning that the first electrode(s) will contact the backside of the carrier mesh and the fiber portions. However, a downside of this configuration may be that the contacts may induce an at least partial local discharge and hence to a less homogeneous plasma-activation. Hence, according to other embodiments, the dielectric barrier discharge device is configured such that the distance between the first electrode(s) and the surface of the backside of the carrier mesh and the fiber portions protruding therefrom is approximately 1 mm to 5 mm, in particular 1 mm to 3 mm. This may reduce the frequency of intermittent local contacts and a partial discharge of the first electrode. The position of the first electrode may be the result of an adjustment of the gap or may be in accordance with the original device architecture.

Hence, the dielectric barrier discharge device preferably allows adjusting the distance of the first and second electrodes such that the carrier mesh with the integrated fibers can be transported through the air gap formed between the surface of the dielectric and the first electrode in one or more of the following two modes: a contact-less mode where the surface of the backside of the carrier mesh and the fiber portions protruding therefrom do not touch the first electrode (except for very rare events where an individual tuft row may be exceptionally high); and an in-contact mode, where the surface of the backside of the carrier mesh and the fiber portions protruding therefrom touch the first electrode at one or more locations or even are in full contact with the first electrode.

In some embodiments, the dielectric barrier discharge device is configured such that the distance between the first electrode(s) and the surface of the backside of the carrier mesh and the fiber portions protruding therefrom is below 10 mm, in particular below 5 mm. For example, the distance may be such that the carrier mesh can be transported through the air gap formed by the surface of the dielectric and the first electrode such that approximately no contact with the first electrode occurs, or such that the first electrode is (continuously and/or on one or more locations) contacted by the backside of the carrier mesh and the fiber portions protruding therefrom.

In general, the use of the dielectric will ensure that even in case of a local contact of the first electrode with the backside of the carrier mesh/a tuft row results in a local discharge, the discharge of the first electrode will not be complete as the effect of the local contact on the voltage field is typically very small relative to the effect of the dielectric which maintains the high voltage field and prevents a sudden complete discharge when a local contact occurs.

In one embodiment, the DBD device comprises one or more distance sensors configured to continuously monitor the carrier mesh which is to be fed into the air gap in order to determine if there exist any objects or elevations in the surface of the carrier mesh/greige good (e.g, particularly high tuft rows or foreign bodies that have got into the production process) which could collide with and damage the first electrode. In case the sensor(s) detect such an object or elevation, a controller of the DBD device automatically increases the air gap between the first electrode and the surface of the dielectric as to avoid a collision, or automatically stops the movement of the carrier mesh.

In one embodiment, the dielectric barrier discharge device is controlled to continuously apply the dielectric barrier discharge (to the backside of the carrier mesh and at least some of the fiber portions protruding therefrom) for plasma activating or plasma-based activation of the backside (the backside of the carrier mesh and at least some of the fiber portions protruding therefrom, e.g., fiber portions forming tuft row surfaces which are exposed to the plasma activation).

In one embodiment, the method is part of a continuously executed, inline roll-to-roll production process comprising: unrolling a carrier mesh roll; tufting the fibers into the unrolled carrier mesh; performing the method according to any one of the previous claims for providing the artificial turf; and forming an artificial turf roll from the provided artificial turf. This may advantageously ensure that the backing is applied shortly after the plasma activation step and the whole roll-to-roll manufacturing process can be executed fully automatically or semi-automatically with minimum delay and highly efficiently.

According to some embodiments, the method is executed by a system for manufacturing the artificial turf, the system comprising the dielectric barrier discharge device, the control unit, the conveyor unit and a dispensing unit. The system may further comprise a fiber inserter configured to receive the artificial turf carrier mesh and artificial turf fiber, and to insert the artificial turf fiber into the carrier mesh. According to embodiments, the system for manufacturing the artificial turf is an inline manufacturing facility for artificial turf. According to embodiments, the fiber inserter (if present), the conveyor unit, the dielectric barrier discharge device and the dispensing unit are elements of the same manufacturing assembly line and are operatively coupled to each other. For example, the operative coupling is implemented such that the carrier mesh comprising the inserted fibers is transported by the conveyor unit from the fiber inserter to the dielectric barrier discharge device for performing a plasma activation of the backside of the carrier mesh and at least some fiber portions of the inserted fibers protruding from the backside, and then transported to the dispensing unit configured to apply the backing layer to the plasma-activated backside of the carrier mesh for providing the artificial turf.

This may have the advantage that the fibers, which may be coupled only loosely to the carrier mesh after their insertion, are strongly integrated in the carrier mesh by performing the plasma activation step and by applying the backing on the plasma-activated backside of the carrier mesh and at least some of the fiber portions protruding therefrom. Hence, the artificial turf output by the inline manufacturing facility and/or by the above-mentioned manufacturing assembly line already comprises fibers which are firmly integrated and will not be lost during later post-processing steps. It is also ensured that no fibers are lost by transporting a carrier mesh with only loosely integrated fibers to a different manufacturing line or a different manufacturing facility.

In one embodiment, plasma activating or plasma-based activation of the backside enables a formation of covalent bonds between the backside and the applied backing layer for providing increased binding between the fibers and the applied backing layer.

In other embodiments, the fibers include polyethylene or polypropylene and/or the carrier mesh includes polypropylene.

In some embodiments, the backing layer is applied in the form of a liquid or fluid mass. For example, the backing layer may be polyurethane or latex.

The backing layer in some cases may be applied using indirect coating performed, for example, via transmission to a cylinder and then a doctor blade to “doctor” or take-off or squeegee excessive coating material. This for example may be used to form the backside from a film formed using, for example, a waterborne polymeric material. Applicable materials for indirect coating include, for example, Styrene-Butadiene latex, Acrylate dispersions, PU-dispersions (Polyurethane dispersions), PE-dispersions (Polyethylene dispersions), PP-dispersions (Polypropylene dispersions), hybrid (PE/PP)-dispersions, PVB (Polyvinylbuturate)-dispersions and mixtures thereof.

The backing layer may also be applied using direct coating using such techniques as k-o-r (knife-over-roll coating, application on a foam table and then taking off (removing) excessive material via a knife/doctor blade (squeegee). The applicable materials for direct coating include, for example, Styrene-butadiene latex, acrylate dispersions, PU-, PE-, PP-, hybrid (PE/PP)-dispersions, PVB (Polyvinylbuturate) dispersions and mixtures thereof.

Further examples of materials for direct coating include reactive 2-component PU coatings comprising a polyurethane compound comprising a mixture of a polyol and an isocyanate component and possibly a filler. These components may be used to form the backing from a film from a waterborne polymeric material applied to the backside or as a reaction of a liquid polymer mixture without solvent or water to a coating layer. The polyol component may, for example, be a polyol mixture with primary and secondary OH-functional. As was mentioned, these coatings may in some examples include a filler such as calcium carbonate, coal-fly-ash, aluminum tri hydrate (ATH), Magnesium Oxide). The coatings may sometimes contain an amine of tin-organic catalyst and/or a drying agent such as natural or synthetic zeolite.

The isocyanate component may be, for example, an isocynate-functional monomer (like Methylene diphenyl diisocyanate (MDI), Toluol-Diisocyanate (TDI), Hexamethylenediisocyanate (HMDI), and Isophorone diisocyanate (IPDI)) or prepolymers made of isocyanate-functional monomers and polyols). In some embodiments, the backing layer is any one of the following: rubber, latex, polyurethane, or a water-based dispersion of polymer particles, e.g: PE, PP, polyacrylates, or polybutadiene.

According to some embodiments, the backing layer is applied in an amount such that in the dried state, there is at least 200 g polyurethane or latex material per m2 artificial turf. According to some embodiments, the backing layer is applied in an amount such that in the dried state, there is about 200 g-800 g, e.g., about 300 g to 650 g polyurethane or latex material per m2 artificial turf. Applicant has observed that thanks to the plasma activation, also for artificial turf types using a small amount of latex or polyurethane of less than 600 g/m2, a tuft bind of over 50 N (after pre-processed the artificial turf according to DIN EN 13744 and then determining the tuft withdrawal force according to FIFA Test Method 26) can be achieved. For example, the tuft binding force can be measured as the force required to pull out a whole tuft bundle and a tuft bind of over 50 N (after pre-processed the artificial turf according to DIN EN 13744 and then determining the tuft withdrawal force according to FIFA Test Method 26) can be achieved.

In another embodiment, the tuft binding force of the artificial turf is over 15 N. This is as determined by a tuft withdrawal force according to FIFA Test Method 26 as specified by FIFA Quality Program for Football Turf. This may for example be found in the Handbook of Test Methods from October 2015.

According to embodiments, the artificial turf comprises less than 600 g/m2 of a latex or polyurethane backing, in particular less than 350 g/m2 of the latex or polyurethane backing, and a tuft withdrawal force of over 40 N, in particular over 50 N (after pre-processed the artificial turf according to DIN EN 13744 and then determining the tuft withdrawal force according to FIFA Test Method 26).

The tuft withdrawal force may be further increased from over 50 N to over 51 N by compressing the fibers on the frontside against the second electrode within the air gap of the dielectric barrier discharge.

In some embodiments, the backside forms a non-planar surface. For example, it may comprise multiple tuft rows Advantageously, the DBD device having a first and second electrode and a dielectric at least partially surrounding the second electrode applies the plasma discharge more uniformly over the backside of a non-planar carrier mesh, as well as over the backside of a planar mesh, resulting in a more homogeneous distribution of plasma-activated sites on the backside, as compared, e.g., to a corona discharge process.

In one aspect, an artificial turf is obtainable (i.e., manufactured) according to any one of the above processes.

In yet another aspect, an artificial turf includes a carrier mesh, where the carrier mesh includes a backside, and where the carrier mesh includes fibers integrated such that a portion of the fibers are exposed on the backside, and a plasma-discharge-assisted homogenously-distributed backing layer positioned on the backside of the carrier mesh and attached to the backside via a homogeneous distribution of binding forces between the backside surface of the carrier mesh and the backing layer.

For example, the homogeneous distribution of binding forces between the backside of the carrier mesh and the backing layer is the result of a homogenous distribution of ions forming covalent bonds between the backside of the carrier mesh and the backing layer.

In particular, the homogeneous distribution of binding forces between the backside of the carrier mesh and the backing layer may comprise a homogeneous distribution of tuft binding forces between a) the backside of the carrier mesh and the exposed fibers on the backside of the carrier mesh and b) the backing layer.

According to some examples, the binding force is a tuft binding force determined by pre-processing the artificial turf according to DIN EN 13744 and then determining the tuft withdrawal force according to FIFA Test Method 26, whereby the tuft binding force is at least 40 N, in particular at least 50 N. The tuft withdrawal force may be further increased from at least 50 N to at least 51 N by compressing the fibers on the frontside against the second electrode within the air gap of the dielectric barrier discharge.

According to some examples, the backside of the carrier mesh contacting the backing is a continuously plasma-treated side of the carrier mesh.

In yet another aspect, disclosed herein is a further method of manufacturing an artificial turf. The method comprises: moving a carrier through an air gap formed between a first electrode and a second electrode of a dielectric barrier discharge device; applying a dielectric barrier discharge to one side of the carrier for plasma-based activation of the side; and using the plasma-activated carrier for manufacturing the artificial turf.

For example, the carrier can be a carrier mesh or a carrier foil. The plasma-activated side may be a backside of the carrier (opposed to the side from which the longer parts of the artificial turf fibers will protrude once the fibers have been integrated). According to some examples, the use of the plasma-activated carrier for manufacturing the artificial turf comprises integrating artificial turf fibers into the plasma-activated carrier, e.g., by means of tufting, weaving, knitting or other types of fiber insertion techniques, and then applying the backing. The dielectric barrier discharge may be applied as described herein for the other embodiments and examples described herein.

In some examples, the artificial turf is manufactured as a web-based process with the carrier entering the process and the finished artificial turf being output or as a series of roll-to-roll processes. As was described previously in the roll-to-roll process, the manufacturing process may be separated into discrete manufacturing steps. For example, artificial turf fibers may be inserted into or attached to the backing on one machine. A complete roll of this semi-manufactured turf could then have the backside of the carrier plasma activated. This roll of material could then be moved to a machine where the backing is applied. Although the manufacturing process is described as a start to finish web-based process it is understood that the individual manufacturing steps can be broken down and performed using a sequence of separate machines.

In another aspect, there is an artificial turf. The artificial turf comprises artificial turf fibers. The artificial turf further comprises a carrier mesh, including a backside. The artificial turf fibers are tufted into the carrier mesh. A portion of the artificial turf fibers are exposed on the backside of the carrier mesh. The artificial turf further comprises a polyurethane layer coating the backside of the carrier mesh. The polyurethane layer secures the portion of the artificial turf fibers to the carrier mesh. For example, the polyurethane layer may be bonded to both the artificial turf fibers and the carrier mesh. The polyurethane layer is formed from a polyol component and an isocyanate component. The polyurethane layer comprises a filler between 215 and 300 parts per weight for every 100 parts per weight of the polyol component. The artificial turf fibers have a turf withdrawal force greater than or equal to 40 newtons. The tuft withdrawal force may be further increased from to over 51 N by compressing the fibers on the frontside against the second electrode within the air gap of the dielectric barrier discharge.

This embodiment may be beneficial because it provides an artificial turf with a sufficient or superior tuft withdrawal force at a substantial cost savings. The filler enables the use of less of the polyurethane layer. However, normally when a filler is used, this causes a reduction in the tuft withdrawal force. In this example, a plasma treatment of the carrier mesh and the portions of the artificial turf fibers before application of the polyurethane layer increased the adhesion sufficiently. Although the filler has been used, the tuft withdrawal force still exceeds 40 N.

In another aspect, there is an artificial turf that comprises artificial turf fibers. The artificial turf further comprises a carrier mesh, including a backside. The artificial turf fibers are tufted into the carrier mesh. A portion of the artificial turf fibers are exposed on the backside. The artificial turf further comprises a polyurethane layer coating the backside of the carrier mesh. The polyurethane layer secures the portion of the artificial turf fibers to the carrier mesh. The polyurethane layer is formed from a polyol component and an isocyanate component. The polyurethane layer comprises a filler above or equal to 150 and below 215 parts per weight for every 100 parts per weight of the polyol component. The artificial turf has a tuft withdrawal force greater than or equal to 50 Newtons.

In another embodiment, the polyurethane layer comprises the filler between 200 and below 210 parts per weight for every 100 parts per weight of the polyol component.

This embodiment may be beneficial because although a lower portion of filler is used, it results in an artificial turf which has a substantially higher tuft withdrawal force. This means that the use of a plasma treatment provides for an artificial turf which has superior tuft withdrawal force. This is therefore a higher quality artificial turf.

In another embodiment, the polyurethane layer comprises the filler between 220 and 260 parts per weight for every 100 parts per weight of the polyol component. This embodiment may be beneficial because it provides a superior tuft withdrawal force with substantial cost savings over the non-use of the large amount of filler material.

In another embodiment, the polyurethane layer comprises the filler between 230 and 260 parts per weight for every 100 parts per weight of the polyol component. As the amount of filler increases, the cost savings increase.

In another embodiment, the polyurethane layer comprises the filler between 240 and 260 parts per weight for every 100 parts per weight of the polyol component. This embodiment results in even greater savings.

In another embodiment, the polyurethane layer comprises the filler between 250 and 260 parts per weight for every 100 parts per weight of the polyol component. This embodiment results in even greater savings.

In another embodiment, the filler is or comprises calcium carbonate. The use of calcium carbonate as a filler enables the smaller amount of the polyurethane layer to be used when there is plasma treatment of the backside of the carrier mesh and the portions of the artificial turf fibers sticking out of the backside.

In another embodiment, the filler comprises any one of the following: calcium carbonate, coal-fly-ash, aluminum tri hydrate (ATH), Magnesium Oxide, and combinations thereof.

In another embodiment, the polyol component is or comprises a mixture of polypropylene glycol diol and a short-chain dysfunctional glycol.

In another embodiment, the polyol component comprises any one of the following: a mixture of a polypropylene glycol diol and a short chain difunctional glycol and a polyol mixture with primary and secondary OH-functional.

In another embodiment, the isocyanate component is or comprises a low functionality polymeric MDI.

In another embodiment, the isocyanate component comprises any one of the following: low functionality polymeric MDI, Methylene diphenyl diisocyanate (MDI), Toluol-Diisocyanate (TDI), Hexamethylenediisocyanate (HMDI), and Isophorone diisocyanate (IPDI).

In another embodiment, the polyurethane layer comprises plasma-discharge enabled or enhanced covalent bonds to the backside and to the artificial turf fibers. When exposed to plasma, the surface of both the backside of the carrier mesh and the surface exposed in the artificial turf fibers have their surfaces activated by the plasma. This means that there may be a larger number of chemical bonds available or chemical bonds of stronger strength.

Exposure to the plasma may have one or more effects on the backside of the carrier mesh and the artificial turf fibers (that extend over the backside). One effect is that the plasma treatment may make the surfaces cleaner enabling better adhesion of the backside to the carrier mesh and the artificial turf fibers. Another effect is that the plasma treatment may enable better formation of better bonds such as enhancing the formation of covalent bonds or the formation of bonds due to the van der Wahl forces.

In another embodiment, the polyurethane layer was applied to the backside of the carrier mesh after plasma-based activation of the backside and the portion of the artificial turf fibers with the dielectric barrier discharge. As mentioned above, this plasma activation or treatment ensures that there is a stronger bond between the polyurethane layer and the backside and the artificial turf fibers.

In another embodiment, the backside and the portion of the artificial turf fibers were plasma activated with the dielectric barrier discharge multiple times. For example, if an electrode is used which provides more than one pass of the dielectric barrier discharge or there are multiple electrodes or multiple dielectric barrier discharge devices, then the surface which is plasma treated may be more uniformly treated, and multiple treatments may also increase the strength of the chemical bonds.

In another embodiment, the tuft withdrawal force is greater than or equal to 40 Newtons when the artificial turf is dry. The tuft withdrawal force may be further increased to 41 Newtons or larger by compressing the fibers on the frontside against the second electrode within the air gap of the dielectric barrier discharge.

In another embodiment, the tuft withdrawal force is greater than or equal to 40 Newtons after soaking the artificial turf in water for between 3 and 6 hours. For example, the water may for example be held at a temperature of 25 to about 30 degrees Celsius for the soaking period. The temperature may also be held at 70 degrees Celsius for a soaking period is two weeks. The tuft withdrawal force may be further increased such that it is greater than or equal to 41 N by compressing the fibers on the frontside against the second electrode within the air gap of the dielectric barrier discharge.

In examples where the polyurethane layer is formed from a polyol component and an isocyanate component. The polyurethane layer comprises a filler above or equal to 150 and below 215 parts per weight for every 100 parts per weight of the polyol component. The artificial turf has a tuft withdrawal force greater becomes greater and may be greater than or equal to 50 Newtons. This is true even when the artificial turf is soaked in water for two weeks in water that is held at 70 degrees Celsius.

In another embodiment, the polyurethane layer comprises a drying agent. The inclusion of a drying agent may be beneficial because it may make the polyurethane layer rougher. This may, for example, help to increase the adhesion between the polyurethane layer and the backside of the carrier mesh or between the polyurethane layer and the artificial turf fibers.

In another embodiment, the drying agent is zeolite. Zeolite is a rough, rock-like material that may help to improve the adhesion between the polyurethane layer and the backside and/or the artificial turf fibers. Zeolite also functions as a drying agent.

In another embodiment, the artificial turf fibers comprises at least one monofilament. Each of the at least one monofilament comprises at least one polymer and a nucleating agent for crystallizing the at least one polymer. The nucleating agent may be an organic or inorganic nucleating agent.

The inorganic nucleating agent consists of one or more of the following: talcum, kaolin, calcium carbonate, magnesium carbonate, silicate, silicic acid, silicic acid ester, aluminium trihydrate, magnesium hydroxide, meta- and/or polyphosphate, and coal fly ash.

The organic nucleating agent may consist of one or more of the following: 1,2-cyclohexane dicarbonic acid salt, benzoic acid, benzoic acid salt, sorbic acid, and sorbic acid salt.

The artificial turf fibers are arranged such that first parts of the monofilaments of the arranged artificial turf fibers are exposed to a bottom side of the carrier and second parts of said monofilaments are exposed to a top side of the carrier and wherein at least the first parts are embedded in and mechanically fixed by the polyurethane layer.

This embodiment may be beneficial because the use of the nucleating agents in the artificial turf fibers provides for an artificial turf with an increased tuft withdrawal force. The plasma treatment of the backside and the artificial turf fibers along with the use of a nucleating agent in the artificial turf fibers may have a synergistic effect on increasing the increase tuft withdrawal force. The use of a nucleating agent increases the roughness of the artificial turf fibers providing for a better mechanical attachment to the polyurethane backing. The plasma treatment increases the number and/or quality of chemical bonds. The increased surface area of the roughened artificial turf fibers to increase the tuft withdrawal force is enhanced by the plasma treatment.

### BRIEF DESCRIPTION OF SEVERAL VIEWS OF THE DRAWINGS

The following embodiments of the invention are explained in greater detail, by way of example only, making reference to the drawings in which:

FIG. 1 shows a production line system for manufacturing an artificial turf, according to an embodiment of the present invention;

FIG. 2 illustrates a portion of the carrier mesh of FIG. 1 after exiting the fiber inserter of FIG. 1, according to an embodiment of the invention;

FIG. 3 illustrates a portion of the carrier mesh of FIG. 1 after exiting the dispensing unit of FIG. 1, according to an embodiment of the invention;

FIG. 4 shows a y-z cross section of the DBD device of FIG. 1, and the control unit 114 of FIG. 1, according to an embodiment of the invention;

FIG. 5 shows a z-x cross-sectional view of the DBD device of FIG. 1, according to an embodiment of the invention;

FIG. 6 shows an overhead perspective view of the DBD device of FIG. 1, according to an embodiment of the invention which uses two wires as first electrodes;

FIG. 7 illustrates a method for method of manufacturing an artificial turf, according to an embodiment of the invention;

FIG. 8 is an illustration of the plasma activation process using a metal bar; and

FIGS. 9A and 9B show experimental data obtained for samples of artificial turf.

FIG. 10 illustrates a portion of a dielectric barrier discharge device.

FIG. 11 shows a rear view of a dielectric barrier discharge device.

FIG. 12 shows a front view of the dielectric barrier discharge device shown in FIG. 11.

FIG. 13 illustrates an alternative arrangement for the electrodes in a dielectric barrier discharge device.

FIG. 14 illustrates an alternative arrangement for the electrodes in a dielectric barrier discharge device.

FIG. 15 illustrates an example of artificial turf with a filler in the polyurethane backing layer.

FIG. 16 illustrates an example of how the tuft withdrawal force is measured.

FIG. 17 illustrates the tuft withdrawal force as a function of filler for both plasma treated and non-plasma treated artificial turf.

FIG. 18 illustrates an alternative arrangement for the electrodes in a dielectric barrier discharge device.

FIG. 19 illustrates an alternative arrangement for the electrodes in a dielectric barrier discharge device.

FIG. 20 illustrates an alternative arrangement for the electrodes in a dielectric barrier discharge device.

### DETAILED DESCRIPTION OF THE INVENTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

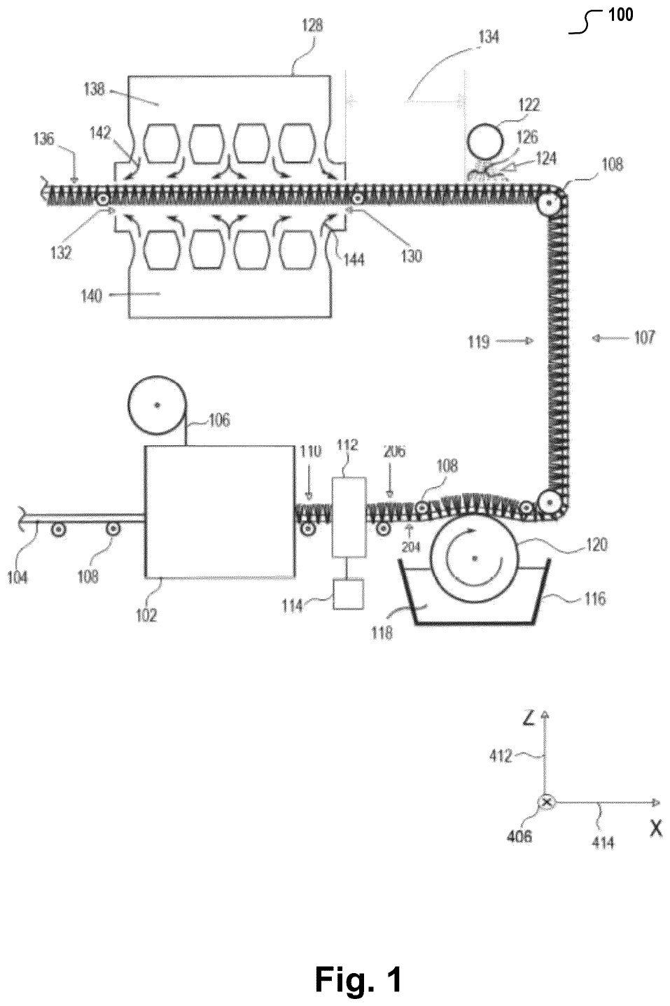

FIG. 1 shows a production line system 100 for manufacturing an artificial turf, according to an embodiment of the present invention. The system includes a fiber inserter 102 configured to receive an artificial turf carrier mesh 104 and artificial turf fiber 106 and insert the artificial turf fiber 106 into the carrier mesh 104, by, for example, weaving or tufting the fiber into the carrier mesh 104. In some embodiments, the fibers include polyethylene or polypropylene and the carrier mesh comprises polypropylene. In other embodiments, the carrier mesh is or comprises a mixture of different polymer fibers, e.g., polypropylene fibers, polyethylene fibers and/or polyamide fibers.

The carrier mesh is also referred to as primary backing. The production line system 100 includes a conveyor assembly 107, including conventional rollers 108, as well other conventional components used in conveyor assemblies, such as drive systems (not shown) for driving one or more of the rollers 108, transport platforms (not shown), etc., configured in combination to move the carrier mesh to (and or through) each processing station, such as through the fiber inserter processing station 102.

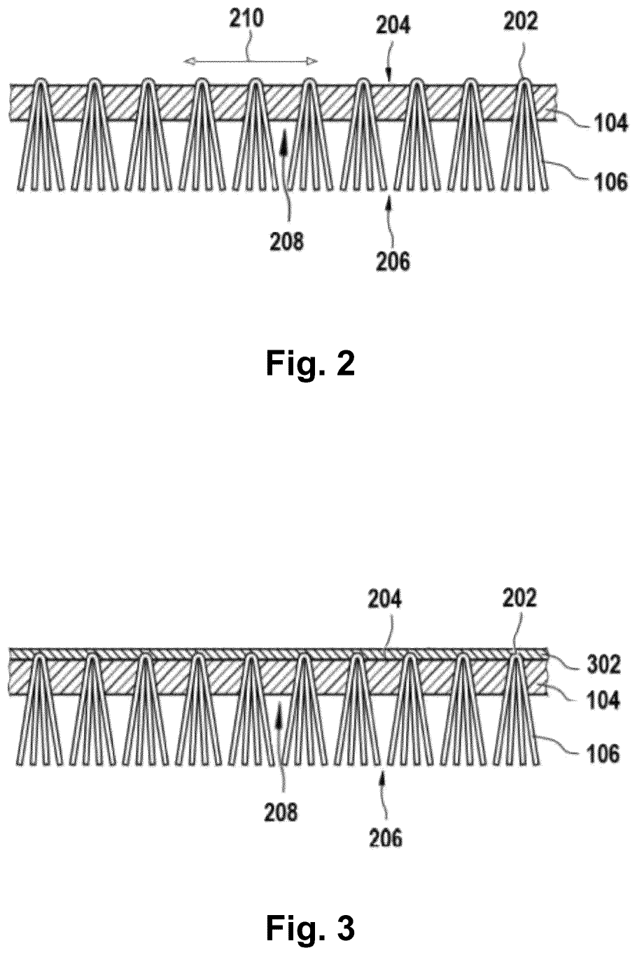

FIG. 2 illustrates a portion of the carrier mesh 104 at location 110 in the system 100 after exiting the fiber inserter 102, according to an embodiment of the invention. In the embodiment illustrated, the carrier mesh 104 includes fibers 106 that have been tufted into the carrier mesh 104. A small loop of tuft fiber 202 extends (i.e., is exposed) on a backside 204 of the carrier mesh 104. Each series of the most closely spaced exposed tuft fibers 202 form a tuft row 210. The distance between two tuft rows can be, for example, 0.2 cm to 2.0 cm, e.g. about 0.25 cm, 0.5 cm or 1.0 cm. The tufted fibers 106 form a pile surface 206 on a front side 208 of the carrier mesh 104.

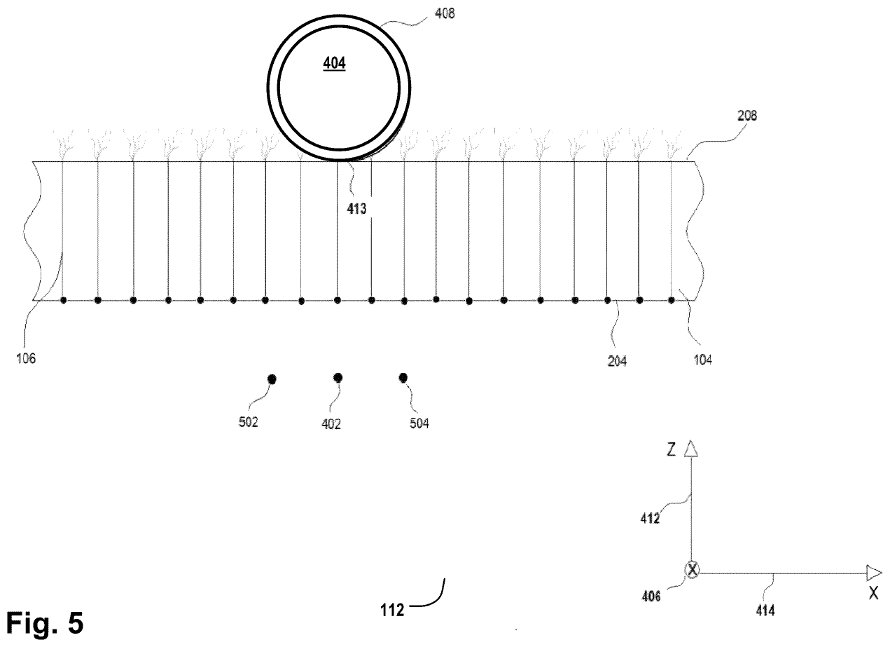

Referring again to FIG. 1, the system 100 includes a dielectric barrier discharge (DBD) device 112 and a control unit 114. As will be discussed in further detail below in conjunction with FIG. 4, the control unit 114 is configured to control the DBD device 112 to apply a dielectric barrier (i.e., plasma) discharge to the backside 204 of the carrier mesh 104 as the carrier mesh 104 moves through the DBD device 112 for plasma-activating or plasma-based activation of the backside 204 in preparation for applying a backing layer, also referred to in the art as a secondary backing or secondary backing layer, by a dispensing unit 116.

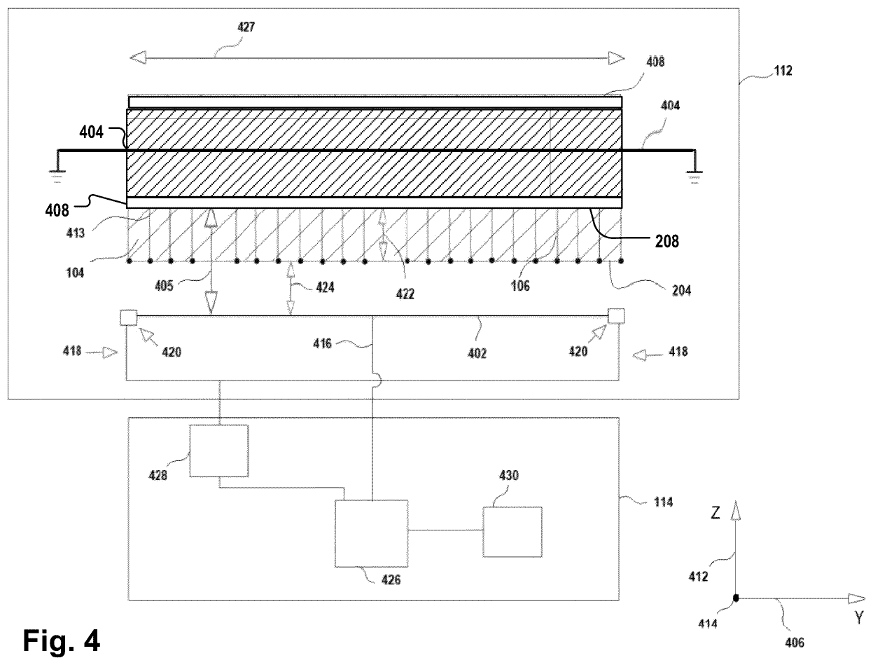

As noted, the dispensing unit 116 applies a backing layer to the plasma-activated backside 204 of the carrier mesh 104. FIG. 3 illustrates a portion of the carrier mesh at location 119 of the system 100, after exiting the dispensing unit 116, according to an embodiment of the invention. FIG. 3 is identical to FIG. 2, with the additional feature of a backing layer coating 302 (e.g., a polyurethane or a colloidal latex backing layer coating) that has been applied to the plasma-activated backside 204 by the dispensing unit 116. The backing layer coating 302, also referred to as a backing layer 302, covers tufted regions (i.e., those regions containing the loops 202), well as the other remaining non-tufted regions of the plasma-activated backside 204 of the carrier mesh 104.

Referring again to FIG. 1, the dispensing unit 116 is configured to coat the plasma-activated backside 204 of the carrier mesh 104 with a polyurethane or latex 118. In one embodiment, the latex 118 is a colloidal latex, however, the polyurethane may be applied as a liquid or a foam. In the exemplary embodiment illustrated, the dispensing unit 116 is a lick roll including a rotating element 120 used to apply the polyurethane or colloidal latex 118 to the plasma-activated backside 204 of the carrier mesh 104. Although it is not shown in the figure, there may be a knife edge or other support structure before and/or after the rotating element 120 to lift and control the height of the backside 204 relative to the rotating element 120.

However, the scope of the invention includes other means of applying the coating 302. For example, and in another exemplary embodiment, the dispensing unit 116 is configured as a knife-over-roll dispensing unit (not shown) for first applying the polyurethane or the colloidal latex onto the plasma-activated backside 204 and then leveling the applied material using the conventional knife-over-roll process. When a knife-over-roll technique is used, the greige good typically has a different orientation, such that the side from which the fibers protrude faces downwards, allowing to apply the liquid backing by pouring or spraying it onto the opposite, upwards-facing side.

For applying the backing layer several different options exist. As was mentioned previously, the backing layer may be applied using indirect coating or direct coating.

Again, the backing layer in some cases may be applied using indirect coating performed, for example, via transmission to a cylinder and then a doctor blade to “doctor” or take-off or squeegee excessive coating material. This for example may be used to form the backside from a film formed using, for example, a waterborne polymeric material. Applicable materials for indirect coating include, for example, Styrene-Butadiene latex, Acrylate dispersions, PU-dispersions (Polyurethane dispersions), PE-dispersions (Polyethylene dispersions), PP-dispersions (Polypropylene dispersions), hybrid (PE/PP)-dispersions, PVB (Polyvinylbuturate)-dispersions and mixtures thereof.

Also again, the backing layer may also be applied using direct coating using such techniques as k-o-r (knife-over-roll coating, application on a foam table and then taking off (removing) excessive material via a knife/doctor blade (squeegee). The applicable materials for direct coating include, for example, Styrene-butadiene latex, acrylate dispersions, PU-, PE-, PP-, hybrid (PE/PP)-dispersions, PVB (Polyvinylbuturate) dispersions and mixtures thereof.

As was previously mentioned, further examples of materials for direct coating include reactive 2-component PU coatings comprising a polyurethane compound comprising a mixture of a polyol and an isocyanate component and possibly a filler. These components may be used to form the backing from a film from a waterborne polymeric material applied to the backside or as a reaction of a liquid polymer mixture without solvent or water to a coating layer. The polyol component may, for example, be a polyol mixture with primary and secondary OH-functional. As was mentioned, these coatings may in some examples include a filler such as calcium carbonate, coal-fly-ash, aluminum tri hydrate (ATH), Magnesium Oxide). The coatings may sometimes contain an amine of tin-organic catalyst and/or a drying agent such as natural or synthetic zeolite.

The isocyanate component may be, for example, an isocynate-functional monomer (like Methylene diphenyl diisocyanate (MDI), Toluol-Diisocyanate (TDI), Hexamethylenediisocyanate (HMDI), and Isophorone diisocyanate (IPDI)) or prepolymers made of isocyanate-functional monomers and polyols).

In some examples, the backing layer is any one of the following: rubber, latex, polyurethane, or a water-based dispersion of polymer particles, e.g.: PE, PP, polyacrylates, or polybutadiene.

The system 110 may optionally include an anti-blistering applicator 122, configured in one embodiment as a spray bar. However, the scope of the invention covers any apparatus/process of applying a preferably small amount of anti-blistering agent 124 to the polyurethane or colloidal latex coating (i.e., to the backing layer coating 302) on the backside 204 of the carrier mesh 104. As illustrated, the applicator 122 is configured to wet a region 126 of the backing layer 302 with the anti-blistering agent 124.

The system optionally includes a heater 128. The heater has an entrance 130 and an exit 132. The applicator 122 may be configured such that the wet region 126 is a distance 134 from the entrance 130 of the heater 128. The system 100 is configured to control the distance 134, via moving the heater 128 or the applicator 122, to control the period between application of the anti-blistering agent 122 to any region of the carrier mesh 104 and entry of this region into the heater 128 via entrance 130. Time periods may vary depending upon ambient environmental conditions, such as ambient temperatures, relative humidity, etc. In one embodiment, the heater 128 and/or the applicator 122 are configured to be moveably adjustable along the path of motion of the carrier mesh 104 on the conveyor assembly 107 for adjusting, either manually by an operator or automatically by the system (e.g., by the control unit 114, based upon operator input and/or sensor data), the distance 134.

The heater 128 is configured to remove water from the backing layer coating 302, thereby curing it for forming a solid backing layer 136. In one embodiment, when the artificial turf carrier mesh 104 exits the heater 128, the manufacturing of the artificial turf by the system 100 is complete, although in additional optional embodiments, the artificial turf fibers 106 may be trimmed after leaving the heater 128. Furthermore, in other embodiments, the backing layer coating 302 may cure before reaching the heater 128 and/or applicator 122, as a result of conditions of the ambient environment, which may be controlled by an operator, and/or length of time after being applied by the dispensing unit 116, and thus the manufacturing of the artificial turf by the system 100 is considered complete before reaching the heater 128 or the applicator 122. In one embodiment, the artificial turf mesh 104 with the integrated fibers 106 and the backing layer 302 exiting the dispensing unit 116 is the manufactured artificial turf of the present invention. In other embodiments, the artificial turf mesh 104 with the integrated fibers 106 and the backing layer 302 exiting the applicator 122 or the heater 128 is the manufactured artificial turf of the present invention.

The heater 128 may function in different ways. In the illustrated exemplary embodiment, the heater 128 has a first heat control element 138 and a second heat control element 140. The first heat control element 138 generates forced air 142 with a first temperature range and the second heat control element 140 generates forced air 144 with a second temperature range. In this way, the temperature of the backside 204 can be controlled to be different from that of the frontside 206 during the curing process. This may lead to effective removal of water from the backing layer coating 302 while protecting the artificial turf fibers 106 against high temperatures.

The manufacturing process and the system for manufacturing an artificial turf depicted in FIG. 1 comprises a fiber inserter 102. However, according to other embodiments (not shown), the artificial turf is manufactured in a roll-to-roll process and the system is free of a fiber inserter 102 or the fiber inserter is not used. For example, the manufacturing process described with reference to FIG. 1 may start with unrolling a roll of greige good (a carrier mesh comprising the already integrated fibers but being free of a backing layer) and the unrolled greige good is fed into the air gap of the dielectric barrier discharge device. Then, the backside of the greige good (opposite to the side from which the fibers protrude) is plasma-activated using a dielectric barrier discharge technique, the liquid backing is applied onto the plasma-activated backside, optionally dried in an oven, and then rolled up to provide a roll of artificial turf.

FIG. 4 shows a y-z cross section of the DBD device 112 of FIG. 1, and the control unit 114, according to an embodiment of the invention. The DBD device 112 includes a first electrode 402 and a second electrode 404 and is illustrated with the carrier mesh 104 partially occupying an air gap g 405 formed between the first and second electrodes 402, 404, as discussed further below. The first and second electrodes 402, 404 are oriented parallel to one another (i.e., both electrodes are elongated in a same first direction 406, or in other words, have longitudinal axes of symmetry, also referred to as major axes of symmetry, that are oriented in the same first direction).

In one embodiment, the first electrode 402 is adjacent to the backside 204 (also referred to as the backside surface 204) of the carrier mesh 104, the second electrode 404 is adjacent to the frontside 208 of the carrier mesh 104, and the second electrode 404 is at least partially encased in a dielectric 408. In embodiments, the dielectric 408 is formed of (homogeneously distributed) dielectric plastic material. In one embodiment, and as measured from the second electrode 404, the dielectric extends a width/thickness in at least in a second direction 412 (i.e., in the −z direction) towards the first electrode 402, where the second direction 412 is perpendicular to the first direction 406. In an embodiment, the air gap g 405 is formed between a bottom edge 413 of the dielectric (i.e., the edge or surface closest to the first electrode 402) and the first electrode. As illustrated, the air gap g 405 is partially occupied by the carrier mesh 104 with the integrated fibers 106, which is being fed though the air gap 405 by the conveyor assembly 107.

The conveyor assembly 107 is configured to move the carrier mesh 104 with the integrated fibers 106 in a third direction 414 (i.e., into or out of the plane of FIG. 4) that is orthogonal to both the first and second directions 406, 412. In one embodiment, the conveyor assembly 107 transports the carrier mesh 104 through the air gap 405 at a speed between 5-15 m/min, preferably between 6-12 m/min, and more preferably between 6-9 m/min. In one embodiment, the speed is dependent upon one or more parameters of the dispensing unit 116 (e.g., a rate at which the backing layer 302 is applied to the plasma-activated backside 204 of the carrier mesh 104).

In another embodiment, the conveyor assembly 107 is configured to move the carrier mesh 104 through the air gap 405 at a manually adjustable and/or an automatically-adjustable speed. For example, the speed may be adjusted by operator input to the control unit 114, and/or the control unit 114 may include software that is configured to automatically determine and/or adjust the speed of the conveyor assembly 107 based upon data input by an operator and/or upon data collected from system sensors, e.g., rate of application of the backing layer mixture 118 from the dispensing unit 116 and/or power applied to the backside 204 of the carrier mesh 104 as a plasma discharge from the DBD device 112. Optionally, the system 112 may comprise one or more distance sensors configured to identify if the carrier mesh comprises any elevations or attached objects which might, upon reaching the first electrode, collide and potentially damage the first electrode. In this case, the controller operatively coupled to the distance sensor(s) to increase the width of the air gap or to stop the movement of the carrier mesh as to prevent the first electrodes being damaged. The distance sensors can be, for example, optical sensors, e.g., cameras, or laser-based distance sensors, or ultrasonic signal-based distance sensors, capacitive distance sensors, etc.

In one embodiment, a single electrode, i.e., the first electrode 402 of the DBD device 112, is electrically coupled to the control unit 114 via a power lead 416. The power lead 114 supplies a voltage to the first electrode, resulting in the DBD device 112 generating a plasma discharge, also referred to as a dielectric barrier discharge, that is directed to (i.e., applied to) the backside 204 of the carrier mesh 104 for plasma-activating or plasma-based activation of the backside 204. In other embodiments, two or more power leads 416 (not shown) are coupled between the control unit 114 and two or more positions along the first electrode 402.

In another embodiment, the DBD device 112 includes a support structure 418 that is configured to be non-electrically (e.g., mechanically) coupled to the first electrode 402 at one or more positions along the first electrode 402, or as illustrated, at two end points 420 of the first electrode 402, for supporting a positioning of the first electrode 402 with respect to the second electrode 404 and with respect to the bottom edge 413 of the dielectric 408 that at least partially encases the second electrode 404, and for setting a width of the air gap g 405. In one embodiment, the support structure 418 is configured to be manually adjustable in at least a vertical direction (i.e., in the z direction 412). Control of the support structure 418 by the control unit 114 will be discussed in more detail further below.

In some embodiments, the thickness of the dielectric 408 is between 0.2 cm to 10.0 cm, e.g., about 2.0-3.0 cm. In other embodiments, given a known carrier mesh width wc 422, as measured from the backside 204 to the frontside 208 of the carrier mesh 104 in a state when the frontside of the carrier mesh rests on a surface, e.g. a roll, and the fiber portions to form the turf are compressed, the air gap g 405 has a width which results in a distance rg 424 measured between the backside 204 of the carrier mesh and the first electrode 402 that is typically less than 1.0 cm, e.g. less than 0.5 cm and preferably less than 0.3 cm. Preferably, the distance 424 of the first electrode(s) is chosen such that a direct contact of the first electrode(s) and the carrier mesh is avoided. However, applicant has observed that due to the uneven surface and the tuft rows, direct contact may not always be avoided, and in some use case scenarios, even a distance 424 of 0 mm, i.e., a basically contact-based configuration of the plasma discharge device, may successfully be used. Surprisingly, applicant has observed that even in case the first electrode occasionally or continuously touches the surface of the carrier mesh, the plasma activation effect is nevertheless distributed homogeneously over the whole length of the first electrode(s), and hence homogeneously over the whole area of the carrier mesh treated. This may be the result of the use of the dielectric enchasing the second electrode, because this dielectric typically has a higher dielectric constant than the material (greige good, carrier) transported through the air gap and prevents the first electrodes to discharge in case the first electrode(s) occasionally or continuously contact the greige good or carrier.

In embodiments, the first electrode 402, also referred to as a counter electrode, the second electrode 404 and the carrier mesh 104 each have at length l 426 of 4 meters. However, the scope of the invention covers counter electrodes, electrodes and/or carrier meshes having different lengths (i.e., smaller and larger).

In one embodiment, the dielectric 408 is a hollow cylinder (or a partial cylinder) that is centered about and extended along a cylinder of metal used as the second electrode 404. However, the scope of the invention includes dielectrics having other shapes, such as elliptical or rectangular. In other embodiments, and particularly for hollow-cylindrically-shaped dielectrics having the second electrode 404 positioned at their respective longitudinal (i.e., major) axes of symmetry, the second electrode 404 including the dielectric 408 surrounds (or at least partially surrounds) the second electrode 404 and is vertically positioned (i.e., positioned in the z direction 412) within the DBD device 112 such that the frontside 206 of the carrier mesh 104 makes contact with the bottom edge 413 (or surface) of the dielectric (i.e., edge (or surface) closest to the first electrode 402) such that the complete cylinder 408 rotates about its longitudinal axis as the carrier mesh 104 is moved through the air gap 405 of the DBD device 112 by the conveyor assembly 107.

In one embodiment, the static frictional force between the frontside 208 of the carrier mesh 104 and the dielectric 408 is large enough to cause the dielectric 408 to rotate about the second electrode 404 as the carrier mesh 104 is moved through the air gap 405 of the DBD device 112 by the conveyor assembly 107 without any slippage between the portions of the dielectric 408 in contact with the frontside 208 of the carrier mesh 104 and the frontside 208 of the carrier mesh 104. Advantageously, neither the frontside 208 of the carrier mesh 104, nor the dielectric 408 surrounding the second electrode 404, build up a static electrical charge. However, if there is slippage (i.e., relative motion) between the carrier mesh 104 and those surface portions of the dielectric in contact with the carrier mesh 104, then the dynamic frictional forces cause by one material contacting and moving with respect to a second material may generate heat, static electricity, and a static voltage potential between the two materials, thereby compromising a uniform distribution of the dielectric barrier discharge (i.e., the plasma discharge) across the backside 204 of the carrier mesh 104, as well as compromising application of the discharge at desired controlled voltages and/or desired controlled temperatures.

The control unit 114 includes a controller 426, a positioning system 428, and a power source 430, such as a transformer. The controller 426 is configured to control the DBD device 112 for applying a dielectric barrier discharge to the backside 204 of the carrier mesh 104 as the carrier mesh 104 moves through the air gap 405 for plasma-based activation of the backside 204. In one embodiment, the controller 426 controls the DBD device 112 to continuously apply a plasma discharge to the backside 204 of the mesh 104 as the mesh 104 moves through the air gap 405. In one embodiment, the controller 426 is configured to enable the power source 430 to apply, via one or more power switches (not shown), a voltage of up to and including 40 kV to the first electrode 402 of the DBD device 112 via the power lead 416.

In an exemplary embodiment, the controller 426 controls the DBD device 112 to continuously apply a plasma discharge to the backside 204 of the mesh 104 as the mesh 104 moves through the air gap 405 at an energy density of between 0.5 J cm² and 0.6 J/cm². In one embodiment, the DBD device 112 delivers the plasma discharge at a power between 500 and 600 Watts as the conveyor assembly 107 moves the mesh at a speed of 6 m/min for applying an energy density of between 0.5 J cm² and 0.6 J/cm² to the backside 204 of the mesh 104. The energy density can be adjusted by controlling the speed of the conveyor assembly 107 and the applied power. For example, decreasing the applied power and/or increasing the conveyor speed reduces the energy density applied to the backside 204 of the mesh 104.

In one embodiment, the control unit 114 is configured to control the dielectric barrier discharge device 122 to apply the dielectric barrier discharge for plasma-based activation of the backside 204 by enabling the formation of covalent bonds between the backside 204 and the backing layer coating 302, as applied by the dispensing unit 116 after the backside 204 is plasma-activated, for providing increased binding between the fibers 106 of the carrier mesh 104 and the applied backing layer 302. In particular, the portions of the fibers exposed on the backside of the carrier mesh (e.g., for fibers tufted into the carrier mesh, as illustrated by FIG. 2, portions of the fibers 202 exposed in the tuft rows 210 on the backside of the carrier mesh), are activated by the plasma discharge (i.e., by the bombardment of the mesh backside 204 (i.e., the backside surface) by high energy ions from the plasma formed in the air gap 405), or in other words, enabling the mesh backside 204 (at an atomic/molecular level) to be receptive to the formation of covalent bonds with the backing layer 302, which is applied shortly thereafter.

In contrast to a corona discharge system, the dielectric 408 of the DBD device 112 limits current flow and distributes the plasma discharge more uniformly over the backside 204 of the carrier mesh 104, thereby enabling the formation of a more homogeneous distribution of covalent binding between the backside 204 and applied backing layer 302, resulting in an overall improvement in the strength of attachment between the backing layer 302 and the fibers 106 of the carrier mesh.

In one embodiment, the system 100 is configured, e.g., via selection of the speed of the conveyor assembly 107 and/or selection of distances between the DBD device 112 and the dispensing unit 116, such that the dispensing unit 116 applies the backing layer coating to a portion of the plasma-activated backside 204 of the carrier mesh 104 within a few hours or preferably a few minutes after plasma activation of that portion by the DBD device 112, so that a significant number of plasma-enhanced receptive sites are still available for forming respective covalent bonds with the backing layer 302 when applied. In one embodiment, a maximum time period for applying the backing layer 302 to a portion of the plasma-activated backside 204 of the carrier mesh 104 is 5 minutes after plasma activation of that portion by the DBD device 112.

In yet another embodiment, the positioning system 428 is coupled to the support structure 418 of the DBD device 112 for moving the support structure 418 in at least a vertical up-down direction (in direction 412). In one embodiment, the positioning system 428 is a distributed positioning system 428 that includes one or more of servos, actuators, switches (mechanical and/or electrical), signal/control lines for transmitting electrical, pneumatic and/or hydraulic control signals for operating the servos and actuators, and sensors, or any combination thereof, distributed throughout the system 100 for moving components of the system 100, such as moving the support structure 418 for adjusting/setting the width of the air gap 405. In other embodiments, the positioning system 428 is configured to also adjust/set other system parameters, without moving any of the system components, such as adjusting/setting the speed of the conveyor assembly 107 for moving the carrier mesh 104, via control/power signals to electrical motors for driving the conveyor assembly 107.

The controller 426 may be configured, e.g., with a user input interface, such that an operator may manually enter data that instructs the controller 426 to adjust the air gap 405, via the positioning system 428, to a desired width. The desired width of the air gap 405 may be based upon one or more of: the voltage to be applied to the first electrode 402, the speed at which the carrier mesh 104 is moved through the air gap 405, the thickness of the dielectric 408, the type of material of the dielectric 408 and/or carrier mesh 104, the width wc 422 of the carrier mesh, the distance rg 424 measured between the backside 204 of the carrier mesh 104 and the first electrode 402, or the ambient environment of the DBD device 112 (e.g., ambient temperature, humidity, etc.), or any combination thereof.

In another embodiment, or in addition to the embodiment of the controller 426 being configured with a user interface, the controller 426 includes software that is configured to automatically determine a desired width of the air gap 405 based on, e.g., operator input to the controller 426, as described above, and/or on data collected by system sensors (not shown) of the distributed positioning system 428. For example, the distribute positioning system 428 may optionally include a motion sensor and/or a width sensor for detecting the speed of the carrier mesh 104 through the air gap 405 and/or the width wc 422 of the carrier mesh 100 integrated with the fibers 106. Motion sensors are well known in the art and will not be discussed in further detail.

In one embodiment, a width sensor includes a vertically moveable mechanical arm that moves in a vertical direction 412 as it remains in contact with the backside 204 of the carrier mesh 104 at a location in the system 100 before the carrier mesh 104 enters the air gap 405. Based on a current vertical position of the moveable arm, a known average width of the carrier mesh 104 integrated with the fibers 106, and the speed of the mesh 104 along the conveyor assembly 107, the controller 426 determines the desired width of the air gap 405 and instructs the positioning system 428 to continuously adjust the air gap width such that the distance rg 424 measured between the backside 204 of the carrier mesh 104 and the first electrode 402 is constant, or essentially constant.

Since carrier meshes may have some width irregularities, the controller 426, using the data received from the width sensor, corrects for width irregularities, thereby ensuring that the distance rg 424 remains essentially at a constant desired value when the plasma discharge is applied to the mesh 104 as the mesh 104 moves through the air gap 405.

In other embodiments, the width sensor of the positioning system 428 is a camera that captures images of either the backside 204 of the carrier mesh 104 or the entire carrier mesh 104 (bounded by the front and backsides 208, 204), as the carrier mesh 104 moves past the camera before the mesh 104 enters the air gap 405. The controller 426 receives the captured images, and using, e.g., edge detection software, detects the vertical position of the backside 204 (and/or frontside 208) of the mesh 104, determines width irregularities in the mesh 104, and instructs the positioning system 428 to adjust the position of the first electrode 402 to keep the distance rg 424 at an essentially constant desired value as the mesh 104 moves through the air gap 405 to receive the plasma discharge.

As mentioned above, the system 112 may comprise one or more distance sensors for identifying the distance of elevations or objects which might collide with the first electrode. The controller may be configured to adjust the width of the airgap, e.g. via the position of the first electrode, based on the measurement data obtained from the distance sensors, such that a collision is prevented.

In embodiments in which the carrier mesh 104 includes the fibers 106 tufted into the backside 204, the distance rg 424 is measured between the portions of the fibers elevated above the backside 204 of the mesh 104 (as a result of the fibers being tufted into the mesh 104) and the first electrode 402. In one embodiment, the backside 204 forms a non-planar surface, where the tuft rows 210 form tufted regions elevated above the other non-tufted regions of the carrier mesh 104. However, the scope of the present invention covers carrier meshes 104 including other types of fiber integration. For example, in another embodiment, the carrier mesh 104 includes fibers incorporated by weaving the fibers into the carrier mesh. Whether the fibers are woven or tufted into the carrier mesh 104, the scope of the present invention covers planar and non-planar carrier mesh backsides 204. In one embodiment, the carrier mesh 104 is positioned on the carrier assembly 107 such that the tuft rows 210 are parallel to the direction of motion of the carrier mesh 104 though the DBD device 112.

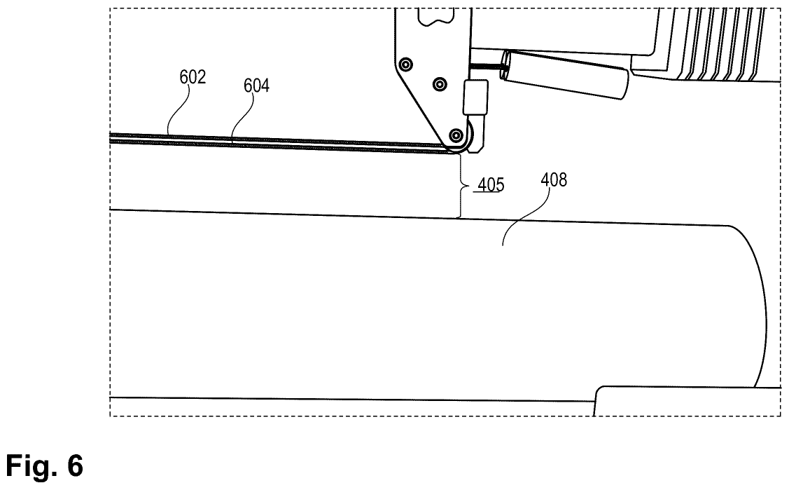

FIG. 5 shows a z-x cross-sectional view of the DBD device 112 of FIG. 1, according to an embodiment of the invention. Reference numbers that are the same as those used in conjunction with FIGS. 1 and 4 reference the same elements. For ease of illustration, the support structure 418 and power lead 416 are not shown.

As illustrated, the DBD device 112 includes the second electrode 404 surrounded by the dielectric 408, formed as a hollow cylinder of dielectric material having a bottom edge 413 (i.e., portion of dielectric surface) contacting the frontside 208 of the carrier mesh 104. The whole cylinder comprising the second electrode and the dielectric is rotatable about the longitudinal axis of the whole cylinder. The DBD device 112 includes the first electrode 402, and may optionally include one or more additional first electrodes, all aligned parallel to one another (all longitudinally extended in the same direction). In the exemplary embodiment as illustrated, the DBD device 112 includes two additional first electrodes 502 and 504. However, the scope of the invention covers other embodiments having any number of parallel oriented first electrodes. Although not shown, each of the optional first electrodes 502 and 504 are coupled to the support structural 418 for support and vertical location adjustment, and with the power supply 430 via the power lead 416. Preferably, the first electrodes are galvanically decoupled from each other.

Advantageously, by using two (or more) parallel first electrodes, e.g., 402, 502, 504, plasma activation of the backside 204, as well as binding between the backside 204 and the applied backing layer 302, is increased due to the increase in total surface area provided by the additional first electrodes, resulting in an increase in the volume of air in the portion of the air gap 405 (that is not occupied by the mesh 104, (i.e., the volume contained within the distance rg 424)) that is transformed into a plasma before the transformation is halted by plasma saturation within the air gap. That is, the volume of air in the gap that can be transformed into a plasma is limited by the number of first electrodes, independent of increasing the applied power above a maximum value corresponding to the onset of plasma saturation. For example, a DBD device including one first electrode may result in maximum binding at 600 Watts, with no appreciable improvement in binding at powers greater than 600 Watts. However, a DBD device having two or more first electrodes operating at 600 Watts has a greater volume of air in the gap before plasma saturation of the gap occurs, and thus an improvement in binding at 600 Watts in comparison, and a possible additional improvement in binding for powers greater the 600 Watts up to a higher maximum power limit. A further advantage may be that in case the voltage field of one first electrode partially breaks down or is reduced due to a contact with the carrier mesh and a resulting partial discharge, the voltage field to the other first electrode(s) remains unaffected, thereby ensuring that the plasma-activation is

According to additional embodiments, a system of the present invention includes the dielectric barrier discharge device 112, the conveyor assembly 107, the control unit 114 and the dispensing unit 116 of FIG. 1, either formed as a separate production line system independent of the production line system 100, or formed as a system including the individual components 112, 107, 114, and 116 (or alternatively the individual components 112, 114 and 116) configured not as a production line or part of a production line.

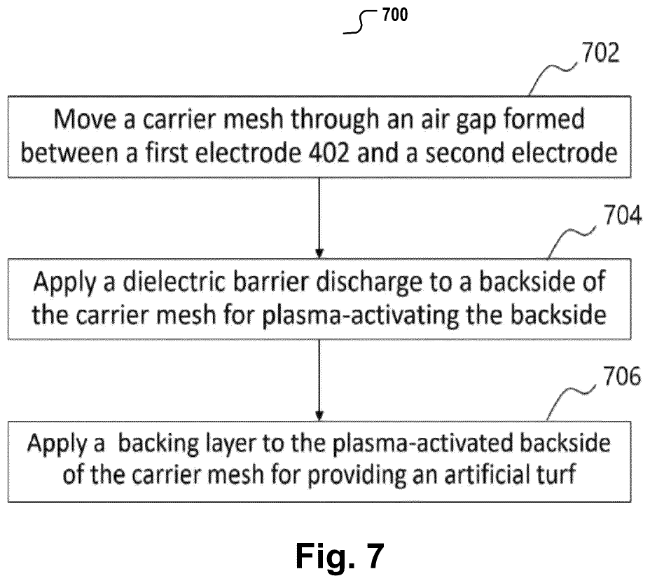

FIG. 6 shows an overhead perspective view of the DBD device 112 of FIG. 1, according to an embodiment of the invention. The DBD device 112 includes two first electrodes 602, 604, where each first electrode is the same as the first electrode 402 (FIG. 4), the dielectric 408 formed as a cylinder that completely surrounds (i.e., encases) the second electrode 404, which is not visible, and the air gap 405 through which the carrier mesh 104 (not shown) is moved. The two first electrodes 602, 604 preferably are parallel metal wires galvanically decoupled from each other.

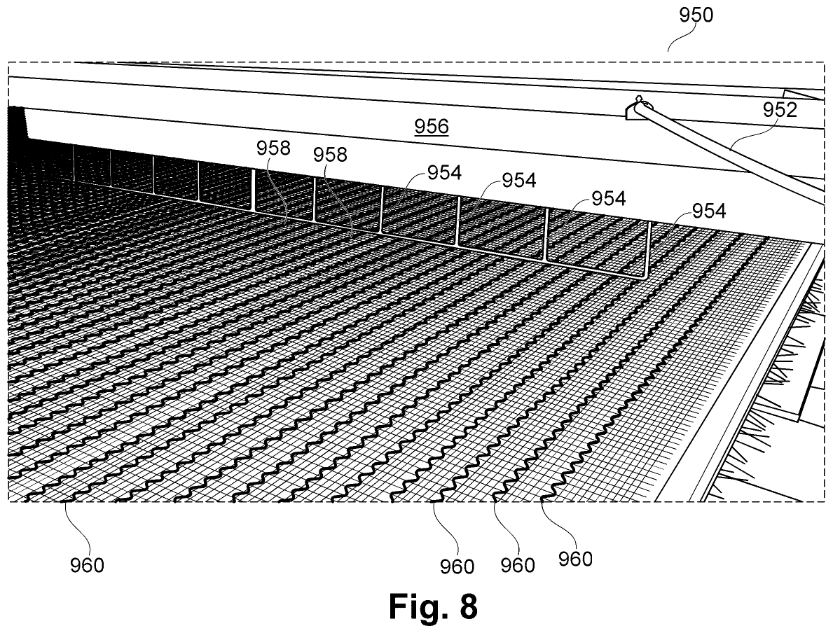

FIG. 7 illustrates a method 700 for method of manufacturing an artificial turf, according to an embodiment of the invention.

In step 702, a carrier mesh 104 is moved through an air gap 405 formed between a first electrode 402 and a second electrode 404 of a dielectric barrier discharge device 112. The carrier mesh 104 includes a backside 204, and the carrier mesh 104 includes fibers 106 integrated such that a portion 202 of the fibers 106 are exposed on the backside 204.

In step 704, a dielectric barrier discharge is applied to the backside 204 of the carrier mesh 104 for plasma-based activation of the backside 204.

In step 706, a backing layer 302 is applied to the plasma-activated backside 204 of the carrier mesh 104 for providing an artificial turf.

There may be an additional step 703, not shown in the figure, which may be performed. In step 703, as the carrier mesh is moved through the air gap 405, the fibers 106 exposed on the front side 204 of the carrier mesh 104 are compressed against the second electrode 404. It may be compressed against a dielectric coating or layer 408 covering the second electrode 404. This may have the effect of eliminating or reducing air between the second electrode and the front side 204 of the carrier mesh 104.

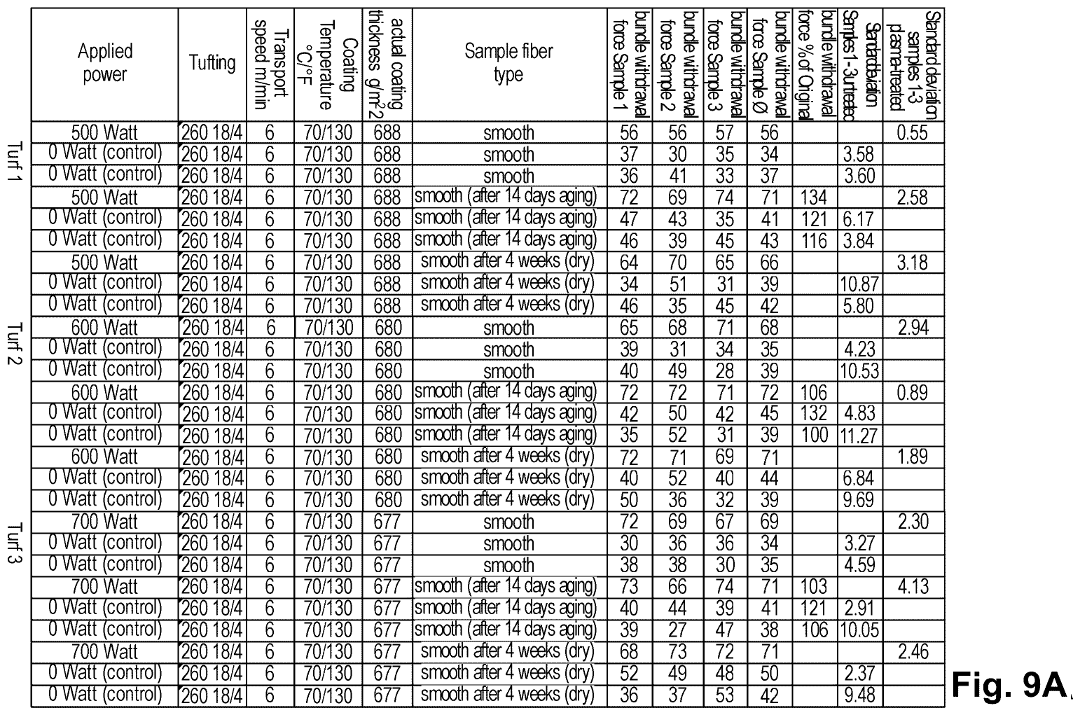

FIG. 8 is an illustration of the plasma activation process. It shows the side of a carrier mesh 960 comprising the tuft rows while the carrier mesh is moved through the air gap between the first electrode 958 and the surface of the dielectric (below the carrier mesh, not shown). In the depicted example, the first electrode is a metal profile having the shape of a rod and being held at a specific, short distance from the surface of the carrier mesh via electrically conductive bars 954. The depicted rod may have a diameter of e.g., 0.2 to 3 mm. The bars may be attached to a frame 956 and may be connected via a cable 952 to a voltage source. As can be inferred from FIG. 8, the first electrode may in some spots be in direct contact with the carrier mesh. Nevertheless, applicant has observed that the plasma activation results in an improved tuft bind and that this effect is homogeneously distributed over the whole surface of the plasma-treated carrier mesh.

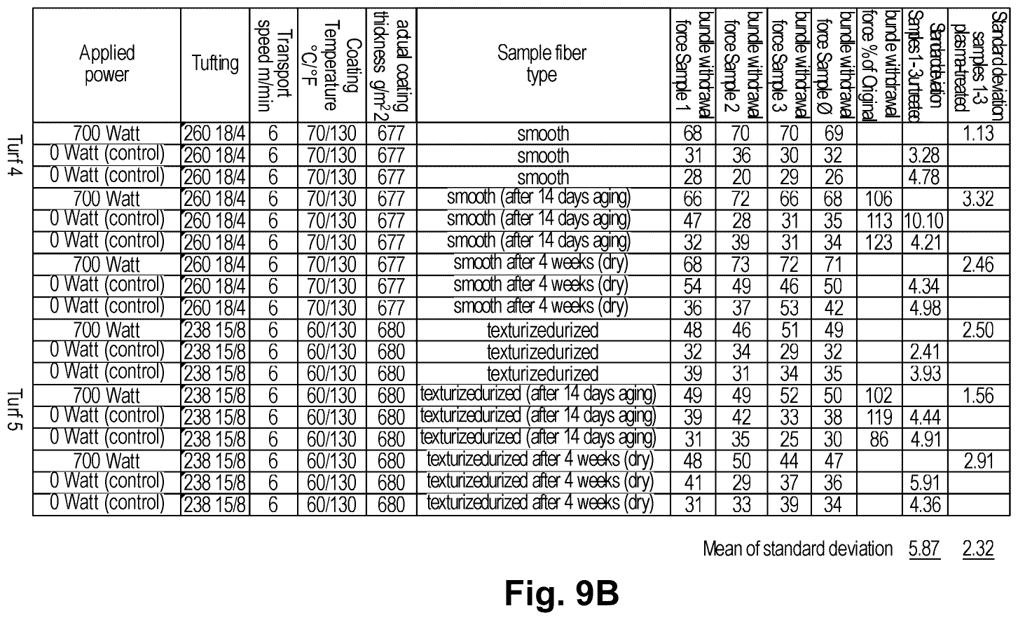

FIGS. 9A and 9B show experimental data obtained for five different artificial turfs. Some properties and process parameters are indicated in respective columns, e.g., stitches per meter, the applied power, the conveyor speed etc. The voltage used for the plasma activation of the turfs 1-5 was, respectively: 32.2 kV, 33 kV, 33.6 kV, 33.6 kV and 33.6 kV. Some turfs comprised smooth fibers, others comprised texturized fibers as indicated in column “sample fiber type”.

After having plasma-activated the turfs, the liquid polyurethane backing was applied and solidified in an oven. Then, the tuft withdrawal force was measured. Some measurements were performed 24 h after the manufacturing process. Other tuft withdrawal force measurements were performed after 14 days of immersing the sample in a 70° C. water-bath (simulated aging) or after 4 weeks (incubation in dry state, no water-bath). The time point of performing the respective measurement is also indicated in the column “sample fiber type”.

The tuft withdrawal force measurements were performed as specified in FIFA “Test Method 26” (Test Manual I—Test Methods: 2015 Edition—FIFA Quality Programme for Football Turf), page 81. The FIFA test 26 comprises selecting and withdrawing one whole tuft and measure the force required to completely withdraw the tuft along a predefined path.

For example, a first section of the first artificial turf was plasma-activated using a dielectric barrier discharge machine. The machine was configured to generate a voltage field of 32.2 kV between the first and second electrodes for applying 500 Watts only onto a first section of the carrier mesh. Two other sections of the same first artificial turf were not plasma-treated (0 Watts) and used as controls. The tuft withdrawal force of the first section of the first artificial turf was measured at different times (lines 1, 4, 7) after the manufacturing process. Likewise, the tuft withdrawal force of the two other sections of the first artificial turf used as controls was measured at different times (lines 2+3, 5+6, 8+9) after the manufacturing process.

Three measurements were made on each of the three different sections of the artificial turf (bundle withdrawal force for sample 1, sample 2 and sample 3).

In addition, the average and standard deviation were computed for the measurement values obtained for each section of the first and the four other artificial turfs. As shown, the average force required to pull out a fiber from the carrier mesh in the plasma activated section is 56 N 24 h after the manufacturing, and the average force required to pull out a fiber from the carrier mesh in the non-plasma activated control sections is 34 and 37 N 24 h after the manufacturing of the first artificial turf. The measurements were repeated after 14 days of aging in a 70° C. water bath and after 4 weeks after manufacturing (storing the artificial turf in dry state, no water-bath). The water-based aging process comprised immersing the five artificial turfs in hot water (70° C.) in accordance with DIN EN 13744. According to DIN EN 13744, the artificial turf to be tested is to be completely immersed in a water bath having a temperature of 70° C. plus/minus 2° C. for 334 to 338 hours (14 days). Then, the artificial turf sections to be tested were taken out of the water and prepared for performing a tuft withdrawal force test as specified in FIFA “Test Method 26” (Test Manual I—Test Methods: 2015 Edition—FIFA Quality Programme for Football Turf), page 81.

A second artificial turf was plasma-activated and used for collecting tuft withdrawal measuring data analogously, whereby the dielectric barrier discharge device was configured to apply 600 Watt on a first section of the second artificial turf while two other sections were not plasma-treated and used as controls. As for the first artificial turf, three measurements each were made on three different sections of the artificial turf (i.e., a section plasma-activated by application of the plasma discharge at 600 Watts, and two control sections (1 and 2) that did not receive the plasma discharge (i.e., 0 Watts)). As shown, the average force required to pull out a fiber from the carrier mesh in the plasma activated section is 68 N 24 h after the manufacturing, and the average force required to pull out a fiber from the carrier mesh in the non-plasma activated control sections 1 and 2 is 35 and 39 N 24 h after the manufacturing.

A third, fourth and fifth artificial turf was (partially) plasma-treated and analyzed for obtaining tuft withdrawal measurement data as described above, whereby 700 Watts were used to plasma-activate the first section of the respective turf.

The measurement results show that the fibers of the plasma-activated sections of the artificial turfs are bound more strongly to the backing-layers in comparison to the fibers of the control sections (non-activated sections), with the rate of increase in tuft-binding per unit applied power decreasing as the applied power approaches 700 Watts. A further increase in applied power results in a negligible increase in tuft-binding, due to plasma-saturation of the gap. This observation was observed consistently in the measurement data obtained from all five artificial turfs shortly and several weeks after the manufacturing. In general, artificial turfs having fibers of smaller gauge, smaller pile height, and smaller number of fiber stiches per meter resulted in weaker tuft binding. The plasma-activation consistently resulted in a tremendous improvement of tuft binding over the non-activated sections.

A comparison of the tuft withdrawal forces observed 24 h after manufacturing with the test data obtained 14 days and 4 weeks after manufacturing further reveals that the tuft binding was stable and did not significantly deteriorate during the 14 days water bath at 70° C. or during the 4 weeks storage in dry state.

A comparison of the standard deviations of the bundle withdrawal forces of the untreated and the plasma-treated pieces of the artificial turfs (see the two rightmost columns and the line “mean of standard deviation) also reveals that the standard deviation of the plasma-treated samples was significantly smaller than that of the non-treated controls. This implies that the plasma-activation was able to provide a tuft bind which was not only significantly stronger than in the un-treated controls, but which was also more homogeneously distributed compared to the tuft bind of the untreated controls.

Furthermore, a long-time test for the turf number 3 for the section treated with 700 Watt was performed seven weeks after production (not shown). The tuft withdrawal force obtained after seven weeks was basically identical to the tuft withdrawal forces measured after two weeks, showing that the plasma activation resulted in a stable, long-lasting enhancement of the tuft bind.

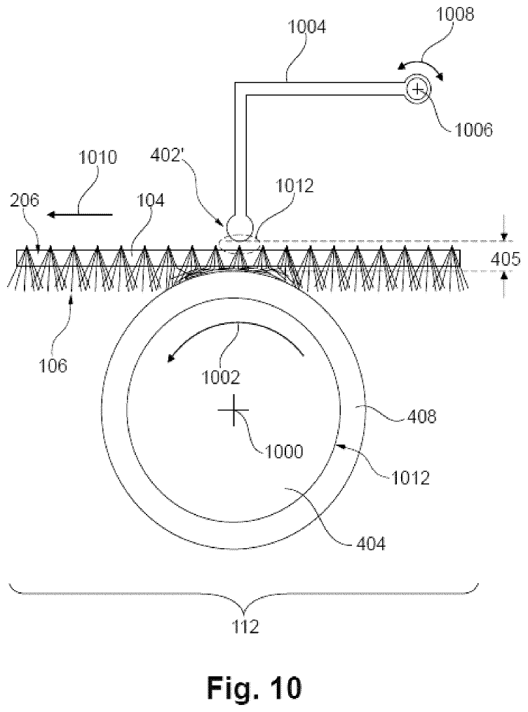

FIG. 10 illustrates portions of a dielectric discharge device 112. There is an air gap 405 formed between a second electrode 404 and a first electrode segment 402′. The first electrode may be formed from a single first electrode segment 402′ or it may be formed from multiple first electrode segments 402′. For example, the multiple first electrode segments 402′ may be rod shaped electrodes arranged in one or more rows.

In FIG. 10, the second electrode 404 is shaped as a cylinder with a cylindrical axis 1000 and a direction of rotation 1002. There is a curved surface 1012 of the second electrode 404 which is exposed to the air gap 405 as the second electrode 404 rotates 1002. The entire curved surface 1012 is coated with the dielectric 408 to prevent arcing between the first electrode segment 402′ and the second electrode 404.

The first electrode segment 402′ is connected to an electrode segment specific pivot arm 1004 that connects the first electrode segment 402′ to a pivot 1006. The pivot 1006 may be placed far enough away from the first electrode segment 4002′ such that motion of the first electrode segment 402′ with respect to the air gap 405 is mostly normal to the curved surface 1012. The first electrode segment 402′ may for example be bar shaped and be positioned parallel to the cylindrical axis 1000. In this example there may be a bar shaped first electrode segment 402′ supported on either end by an electrode segment specific pivot arm 1004.

There is a carrier mesh 104 with fibers 1006 and a back side 206 that is travelling through the air gap 405 in the second direction 1010. The second direction 1010 is the direction of motion of the carrier mesh 104 and it is perpendicular to the cylindrical axis 1000. It can be noted that the fibers 1006 are bunched up between the carrier mesh 104 and the dielectric 1408. This may cause the height of the carrier mesh 104 to vary slightly or to change as the carrier mesh 104 travels in the direction of motion 1010. In this example the first electrode segment 402′ is mounted above the second electrode 404 and gravity enables the electrode segment specific pivot arm 1004 to rotate 1008 about the pivot 1006. The first electrode segment 402′ may be allowed to rest on the back side 206 or have a spacer to support the first electrode segment 402′ at an optimal distance. The region marked 1012 is where the dielectric barrier discharge is formed to treat or plasma-modify the back side 206.

The view in FIG. 10 is a cross-sectional view. The first electrode segment 402′ extends in a linear direction parallel to the cylindrical axis 1000. In some examples the first electrode may be formed from multiple first electrode segments 402′. They may be electrically isolated and may be used to control the plasma over a segment extending in the direction of the cylindrical axis 1000.

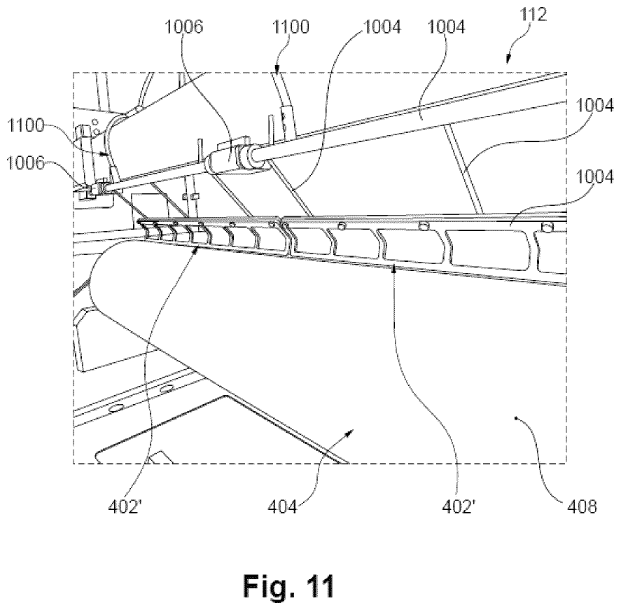

FIG. 11 shows a prototype electric discharge device 112. In this example, the carrier mesh 104 is not shown. There are two separate first electrode segments 402′ that are shown as resting on the dielectric 408 of the second electrode 404. Visible is the electrode segment specific pivot arm 1004 that connects the first electrode segment 402′ to the pivot 1006. In this example there are separate electrical connections 1100 provided to each of the first electrode segments 402′. FIG. 11 shows a back view of the dielectric discharge device 112.

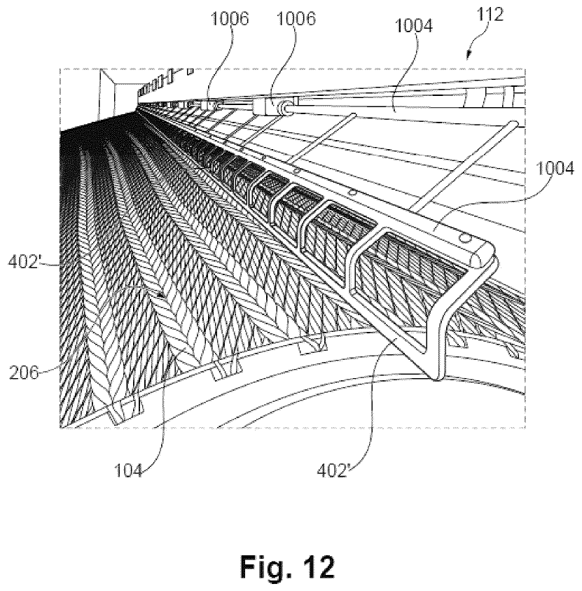

FIG. 12 shows a front view of the same dielectric discharge device 112 as was depicted in FIG. 11. In this example, there is a back side 206 of the carrier mesh 104 covering the second electrode 404 which is no longer visible. There are multiple first electrode segments 402′ that are shown as resting on the back side 206. As was depicted in FIGS. 10 and 11, the first electrode segments 402′ are able to pivot freely about the pivot locations 1006. In FIGS. 11 and 12 it is shown how the multiple first electrode segments 402′ form a continuous line across the length of the second electrode 404 to provide an unbroken dielectric barrier discharge 1012 to surface treat the back side 206 of the carrier mesh 104.

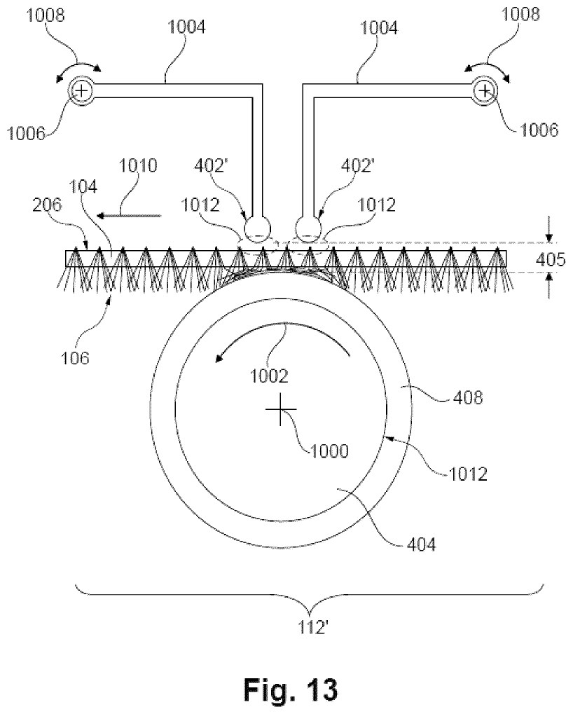

FIG. 13 illustrates an alternative dielectric discharge device 112 to that depicted in FIGS. 10-12. In FIG. 13, the dielectric discharge device 112′ has a second row of first electrode segments 402′. In this example two dielectric barrier discharge regions 1012 formed adjacent to each other. An advantage of this is that as the carrier mesh 104 travels through the dielectric discharge device 112′ every region is treated with the dielectric barrier discharge 1012 twice. This helps to ensure that the entire back side 206 and fibers 106 extending to the back side 206 are treated. This may lead to better adhesion when the backing layer is applied to the carrier mesh 204. The independent pivoting of the opposing electrode specific pivot arms 1004 helps to ensure that the plasma treatment from each discharge 1012 is uniform.

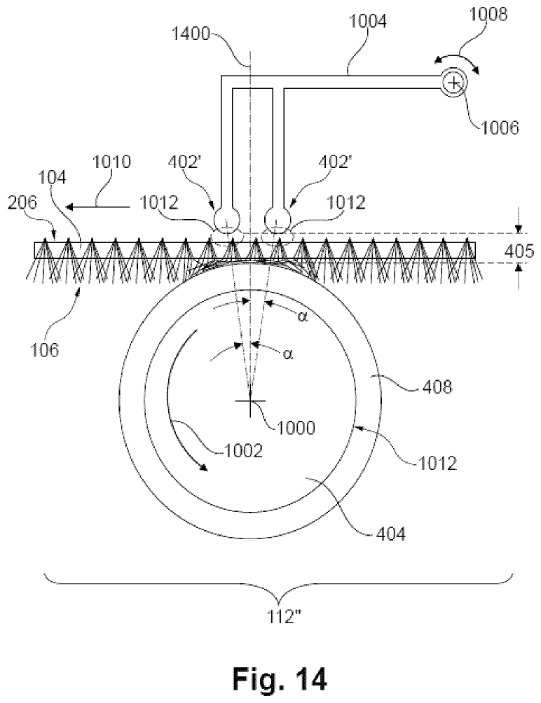

FIG. 14 illustrates a further example of a dielectric barrier discharge device 112″. In this example, there are two first electrode segments 402′ that are connected to the same electrode segment specific pivot arm 1004. For example, this may be realized by having two bar-shaped first electrode segments 402′ electrode segments 402′ connected by a forked electrode segment specific pivot arm 1004. An advantage of this arrangement is that the backside 206 of the carrier mesh 104 is twice as it passes through the dielectric barrier discharge device 112″.

In some examples, the two first electrode segments 402′ may be arranged so that they are symmetrical bout a vertical axis of symmetry 1400 for the second electrode 404. The vertical axis of symmetry 1400 is vertical with respect to the earth and passes through the cylindrical axis of symmetry 1000. Both electrode segments 402′ in some examples may be spaced so that they are both at an angle with respect to the vertical axis of symmetry 1400. An advantage of this arrangement is that the gravitational force causes both first electrode segments 402′ to exert the same downward force on the backside 206 of the carrier mesh.

In some examples, both two first electrode segments 402′ may be powered with the same power supply. In other examples, the two first electrode segments 402′ may be provided with a separate power supply.

In general, the separate power supplies, in some cases, may use the second electrode 404 as a common anode. In some cases, the second electrode may function as a common ground for the separate power supplies. The power supply or separate supplies may, for example, supply radio frequency (RF) power or be pulsed power supplies. This applies to the multiple electrode segments 402′ as shown in both FIGS. 12 and 13. It is possible to power each of the multiple electrode segments 402′ separately using the second electrode 404 as the common anode.

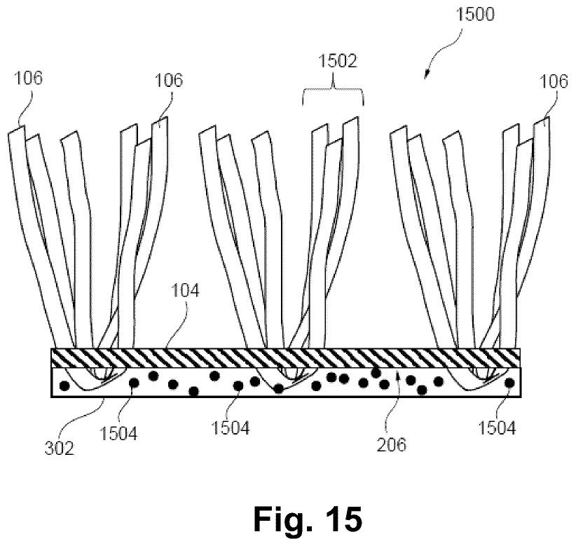

FIG. 15 illustrates an example of artificial turf 1500. The artificial turf comprises 1500 a carrier mesh 104 and artificial turf fibers 106 that are tufted into the carrier mesh 104. There are individual tufts 1502 of artificial turf. There is a backing layer 302 which is attached to a backside 206 of the carrier mesh 104. The backing layer 302, in this case, is a polyurethane layer that attaches to both the backside of the carrier mesh 104 and the artificial turf fibers 106 that partly extend out past the backside. The polyurethane layer 302 is shown as containing a filler 1504. This filler may, for example, be calcium carbonate. Adding the calcium carbonate has the effect of reducing the amount of polyurethane used, but it also reduces the tuft withdrawal force. In this case, both the backside of the carrier mesh 104 and the portion of the artificial turf fibers 106 extending out past the backside have been plasma treated beforehand. This increases the chemical bonding between the polyurethane layer 302 and both the backside of the carrier mesh 104 and the artificial turf fibers 106. Although there may be an elevated amount of filler 1504, the tuft withdrawal force is still sufficiently large.

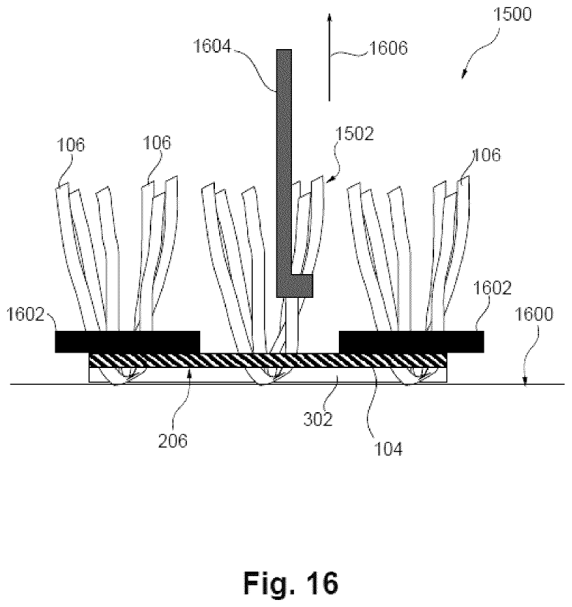

FIG. 16 illustrates an example of a machine for testing the tuft withdrawal force 1606. The artificial turf of 1500, as illustrated in FIG. 15, is shown as being placed on a surface 1600. There is a retaining plate, 1602, which is used to hold a portion of the artificial turf 1500 in place. An area not supported by the retaining plate 1602 has a puller arm or mechanism 1604 that grabs a single tuft 1502 of the artificial turf 1500. This puller arm 1604 is then moved in the direction 1606 with increasing force until the tuft 1502 is pulled free. In this way, the tuft withdrawal force 1606 may be measured.

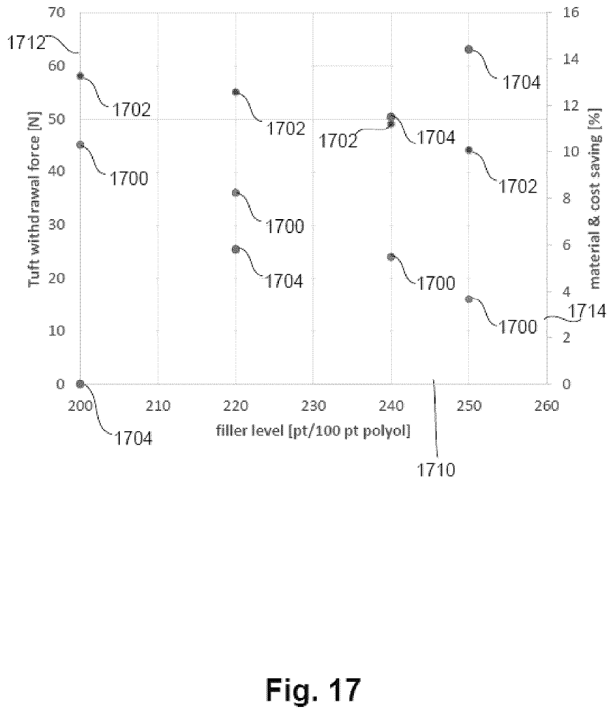

FIG. 17 shows a plot with the x-axis 1710 as the amount of filler or filler level in parts per 100 parts of polyol used to make the polyurethane coating 302. On the left-hand side, the y-axis 1712 is the tuft withdrawal force in Newtons. On the right, the axis 1714 is the material cost and savings as a percentage. As the amount of filler increases, the cost savings 1714 increase also. In the example illustrated in FIG. 17, the polyol component was a mixture of a polypropylene glycol diol and a short chain difunctional glycol, the isocyanate component was low functionality polymeric MDI, and the filler used was calcium carbonate.

The points labeled 1700 represent the tuft withdrawal force without any plasma treating of the backside 206 of the Carrier Mesh 104. The dots labeled 1702 indicate the tuft withdrawal force for tufts 1500, where the backside 206 of the Carrier Mesh 104 and the artificial turf fibers 106 were plasma treated as described herein. The points labeled 1704 indicate a material and cost savings in percentage. In examining this graph, the plasma-treated 1702 tuft withdrawal force is significantly higher than the withdrawal force for the non-plasma-treated case, 1700. As the amount of filler level 1710 increases, the difference between the plasma-treated 1702 and the non-plasma-treated 1700 increases. It can also be seen that as the filler level increases, the use of the plasma treatment enables a large cost-saving, 1704.

The tuft withdrawal force may be further improved by using modified artificial turf fibers. In this further example, the artificial turf fibers comprises at least one monofilament. Each of the at least one monofilament comprises at least one polymer and a nucleating agent for crystallizing the at least one polymer. The nucleating agent may be an organic or inorganic nucleating agent.

The inorganic nucleating agent consists of one or more of the following: talcum, kaolin, calcium carbonate, magnesium carbonate, silicate, silicic acid, silicic acid ester, aluminium trihydrate, magnesium hydroxide, meta- and/or polyphosphate, and coal fly ash.

The organic nucleating agent may consist of one or more of the following: 1,2-cyclohexane dicarbonic acid salt, benzoic acid, benzoic acid salt, sorbic acid, and sorbic acid salt.

The artificial turf fibers are arranged such that first parts of the monofilaments of the arranged artificial turf fibers are exposed to a bottom side of the carrier and second parts of said monofilaments are exposed to a top side of the carrier and wherein at least the first parts are embedded in and mechanically fixed by the polyurethane layer.

This embodiment may be beneficial because the use of the nucleating agents in the artificial turf fibers provides for an artificial turf with an increased tuft withdrawal force. The plasma treatment of the backside and the artificial turf fibers along with the use of a nucleating agent in the artificial turf fibers may have a synergistic effect on increasing the increase tuft withdrawal force. The use of a nucleating agent increases the roughness of the artificial turf fibers providing for a better mechanical attachment to the polyurethane backing. The plasma treatment increases the number and/or quality of chemical bonds. The increased surface area of the roughened artificial turf fibers to increase the tuft withdrawal force is enhanced by the plasma treatment. The tuft withdrawal force may be further increased by compressing the fibers exposed on the frontside that are within the air gap between the two electrodes against the second electrode.

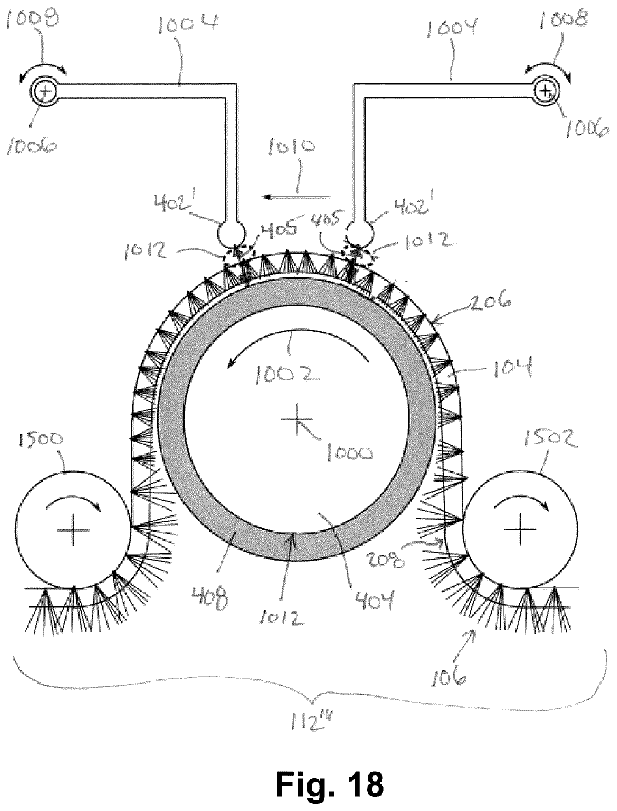

FIG. 18 illustrates a further example of a dielectric barrier discharge device 112′″. This example is similar to the dielectric barrier discharge 112′ illustrated in FIG. 13. Additionally, there is a first tensioning roller 1500 and a second tensioning roller 1502 that are mounted below the axis of rotation of the second electrode 1012. The second electrode 1012 is shown as comprising a dielectric layer 408 covering its cylindrical surface. The two tensioning rollers 1500, 1502 pull the front side 208 of the carrier mesh 104 against the exposed surface of the dielectric 408. This causes the fibers 106 to be compressed on the front surface.

This may have several effects; this may make the carrier mesh 104 more compact and enable the first electrodes 1004 to be moved into a closer position. The electrodes 1004 are referred to as first electrode portions in this figure. They may be powered separately and may be used to generate separate dielectric barrier discharges 1012.

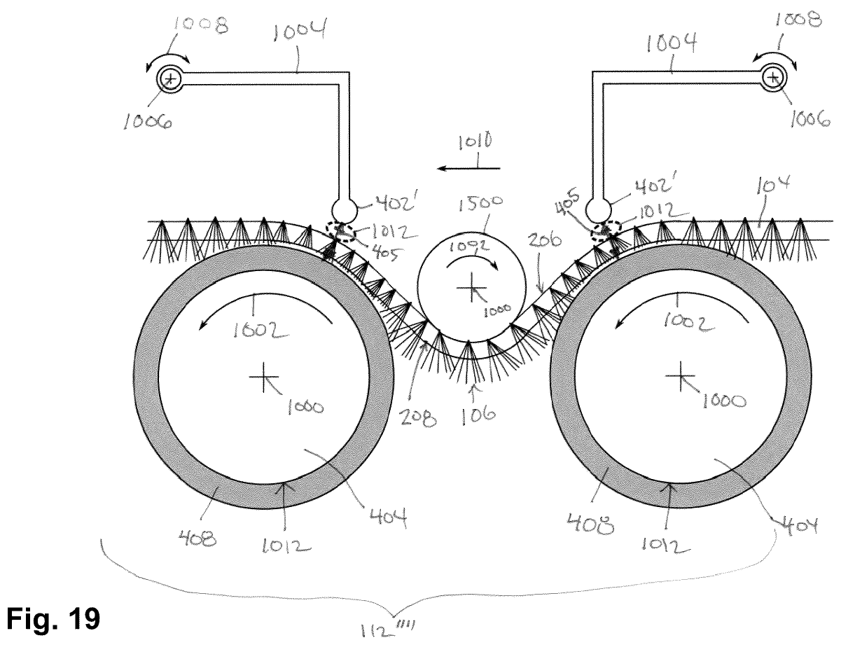

FIG. 19 illustrates a further example of a dielectric barrier discharge device 112″″. In this example, there are two cylindrical second electrodes 1012. They are referred to as cylindrical second electrode portions. There is a tensioning roller 1500 mounted between the two horizontally mounted second electrodes 1012. By moving the tensioning roller 1500 in a downward motion more pressure may be exerted on the front surface 208 of the carrier mesh 104. This again, may press the fibers 106 against the dielectric layer 408. This reduces the available air in the air gap and may hinder the forming of a dielectric barrier discharge between the front side 208 and the second electrode 1012. Above each second electrode 404 there is a first electrode 402′ mounted above the backside 206. This results in two dielectric barrier discharges 1012. The individual first electrodes 402′ may be powered independently. They may have separate power supplies so if there is instability in one of the dielectric barrier discharges 1012 it does not affect the other.

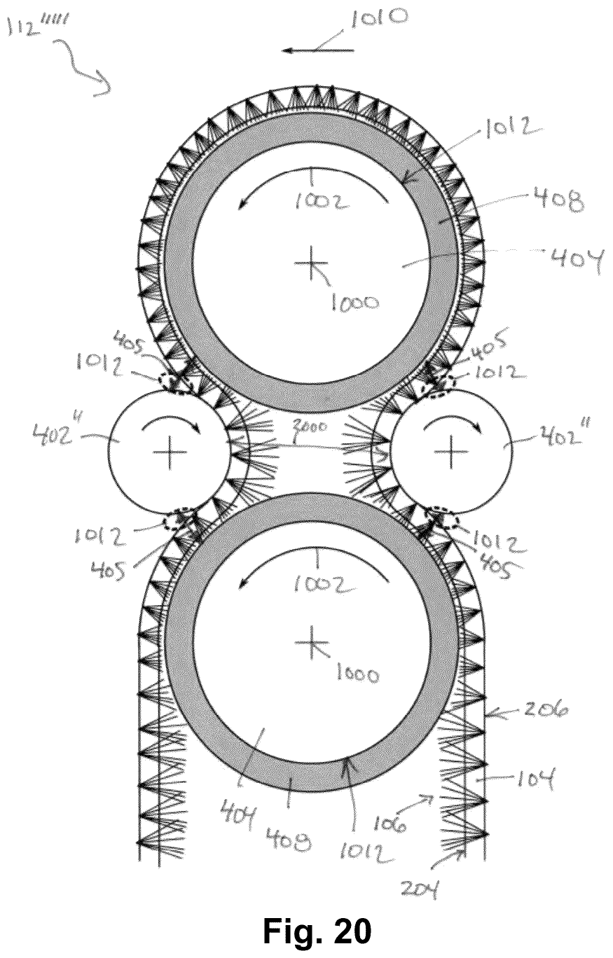

FIG. 20 shows a further example of a dielectric barrier discharge device 112′″″. In this example, there are two cylindrical second electrodes 404 that are mounted vertically from each other. The first electrode takes the form of a pair of cylindrical first electrode portions 402″. The two cylindrical first electrode portions 402″ are separated by an adjustable gap 2000. By adjusting this gap the carrier mesh 104 may be compressed against the second electrodes 1012. This may allow a very high degree of compression of the fibers 106. This may for example be useful in greatly reducing or nearly eliminating the possibility of a dielectric barrier discharge forming between the first surface 204 and the dielectric 408. In some instances, there may be a chance of a dielectric barrier discharge forming between the adjustable gap 2000. This however, may be hindered by the presence of the fibers 106.

An advantage of the mechanical arrangement shown in FIG. 20 allows control of the compression without the need to stretch the carrier mesh 104. The compression of the fibers 106 is related to how close the gap 2000 is which may be used to directly control the amount of compression. This degree of control over the compression may outweigh the chances of the dielectric barrier discharge forming in the adjustable gap 2000.

Various examples may possibly be described by one or more of the following features in the following numbered clauses:

Clause 1. A method of manufacturing an artificial turf, comprising:
moving a carrier mesh (960) through an air gap (405) formed between a first electrode (602, 604, 402) and a second electrode (404) of a dielectric barrier discharge device (112), wherein the carrier mesh includes a backside, and wherein the carrier mesh includes fibers integrated such that a portion of the fibers is exposed on the backside;
applying a dielectric barrier discharge to the backside of the carrier mesh for plasma-activating the backside; and
applying a backing layer to the plasma activated backside of the carrier mesh for providing the artificial turf.

Clause 2. The method of clause 1, wherein the outer surface of a dielectric at least partially encases the second electrode.

Clause 3. The method of clause 2, wherein the dielectric covers the second electrode to provide electrical isolation to form the dielectric barrier discharge.

Clause 4. The method of clause 1, 2, or 3, wherein the first and second electrodes are elongated in a first direction, and wherein the carrier mesh is moved in a second direction that is perpendicular to the first direction.

Clause 5. The method of any one of clauses 1 through 4, wherein the carrier mesh includes a frontside, wherein the first electrode is adjacent to the backside, and wherein the second electrode is adjacent to the frontside, and wherein dielectric extends at least in a direction towards the first electrode.

Clause 6. The method of any one of clauses 2 through 5, wherein the second electrode is a metal cylinder which is at least partially encased in the dielectric.

Clause 7. The method of clause 6, wherein the second electrode comprises a curved surface symmetric about a cylindrical axis (1000), wherein the dielectric covers at least the curved surface.

Clause 8. The method of clause 7, wherein the carrier mesh is moved through the air gap perpendicular to the cylindrical axis.

Clause 9. The method of clause 7 or 8, wherein the method further comprises rotating the second electrode about the cylindrical axis during transport of the carrier mesh through the air gap.

Clause 10. The method of clause 9, wherein the first electrode is formed from at least one first electrode segment (402′), wherein the at least one first electrode segment is mounted above the curved surface and extends along the cylindrical axis to form at least a portion of the air gap parallel to the cylindrical axis.

Clause 11. The method of any one of clauses 1 through 5, wherein the first electrode is formed from at least one first electrode segment (402′), wherein the at least one electrode segment is mounted above the second electrode.

Clause 12. The method of clause 10 or 11, wherein the at least one first electrode segment forms collectively at least one dielectric barrier discharge line across a width of the carrier mesh.

Clause 13. The method of clause 10, 11, or 12, wherein the at least one first electrode segment is assisted by gravity to form the air gap.

Clause 14. The method of any one of clauses 10 through 13, wherein the at least one electrode segment is mounted to an electrode segment specific pivot arm (1004) that rotates (1008) the at least one first electrode segment into position to form the air gap.

Clause 15. The method of clause 14, wherein gravitational forces cause the at least one first electrode segment to contact the backside during application of the dielectric barrier discharge.

Clause 16. The method of any one of clauses 10 through 15 wherein the at least one electrode segment is multiple first electrode segments.

Clause 17. The method of clause 16, wherein the multiple first electrode segments are configured for independent motion to form the air gap.

Clause 18. The method of clause 17, wherein the multiple first electrode segments are arranged to form multiple air gaps with the first electrode such that the backside is plasma activated multiple times.

Clause 19. The method of any one of clauses 16 through 18, wherein the multiple first electrode segments are electrically isolated.

Clause 20. The method of clause 19, wherein the multiple first electrode segments are connected to independent power supplies.

Clause 21. The method of any one of the preceding clauses, wherein the method further comprises applying the dielectric barrier discharge to the backside of the carrier mesh multiple times.

Clause 22. The method of clause 21, wherein the dielectric barrier discharge is applied to the backside of the carrier multiple times by using multiple dielectric barrier discharge devices.

Clause 23. The method of clause 21 or 22, wherein the dielectric barrier discharge is applied to the backside of the carrier multiple times by locally moving the carrier through the dielectric barrier discharge device in a reciprocating fashion.

Clause 24. The method of any one of the previous clauses, wherein the dielectric comprises a plastic material.

Clause 25. The method of any one of the previous clauses, wherein the dielectric has a thickness of at least 0.2 cm, in particular a thickness of 0.2 cm to 10.0 cm, in particular a thickness of 1 cm to 5 cm, preferably a thickness of between 2.0 cm to 3.0 cm.

Clause 26. The method of any one of the previous clauses, wherein the dielectric is shaped as a hollow cylinder with circular or ellipsoid cross section, wherein the second electrode is elongated along a major axis of the dielectric, and wherein the dielectric is in contact with the frontside of the carrier mesh.

Clause 27. The method of any one of the previous clauses, wherein the second electrode is at least partially encased in the dielectric and is configured to be rotatable about its longitudinal axis.

Clause 28. The method of clause 27, wherein rotating the second electrode with the dielectric moves the carrier mesh through the air gap formed between the first electrode and the second electrode.

Clause 29. The method of any one of the preceding clauses, wherein the moving of the carrier mesh through the air gap comprises moving the carrier mesh through the air gap at a manually adjustable and/or automatically-adjustable speed.

Clause 30. The method of any one of the preceding clauses, wherein the applying the dielectric barrier discharge comprises applying the dielectric barrier discharge at an energy density of at least 0.1 J/cm², in particular of at least 0.3 J/cm², in particular of at least 0.5 J/cm², and in particular between 0.5 J/cm² and 0.6 J/cm².

Claus 31. The method of any one of the preceding clauses, further comprising manually or automatically adjusting a gap between the first electrode and second electrode.

Clause 32. The method of clause 31, wherein the gap is adjusted such that a distance between the first electrode and the outer surface of the dielectric at least partially enchasing the second electrode is greater than 0 mm, in particular greater than 10 mm, in particular greater than 15 mm, in particular greater than 20 mm, in particular greater than 30 mm, in particular between 25 mm and 80 mm, in particular between 40 mm and 80 mm.

Clause 33. The method of any one of the preceding clauses, wherein the first electrodes are positioned such that a distance between the first electrode and a surface of the backside of the carrier mesh and the fiber portions protruding therefrom is below 10 mm, in particular below 5 mm, in particular between 0 mm and 3 mm.

Clause 34. The method of any one of the preceding clauses, wherein the applying of the dielectric barrier discharge further comprises controlling the dielectric barrier discharge device to continuously apply the dielectric barrier discharge for plasma-activating the backside.

Clause 35. The method of any one of the preceding clauses, wherein the first electrode is a single wire or a set of two or more wires (602, 604).

Clause 36. The method of any one of the preceding clauses, wherein the first electrode is a conductive profile, in particular a metal rod or metal bar (958) or a set of two or more of said profiles.

Clause 37. The method of any one of the preceding clauses, wherein the first electrode is a set of two or more conductive wires or profiles galvanically decoupled from each other.

Clause 38. The method of any one of the preceding clauses, wherein the method is part of a continuously executed, inline roll-to-roll production process comprising: unrolling a carrier mesh roll; tufting the fibers into the unrolled carrier mesh; performing the method according to any one of the previous clauses for providing the artificial turf; and forming an artificial turf roll from the provided artificial turf.

Clause 39. An artificial turf, comprising:
a carrier mesh (960) including a backside, wherein the carrier mesh includes fibers integrated such that a portion of the fibers is exposed on the backside; and
a backing layer positioned on the backside of the carrier mesh and connected to the backside via a plasma-discharge-assisted homogeneous distribution of binding forces between a backside surface of the carrier mesh and the backing layer.

Clause 40. The artificial turf of clause 39, wherein the homogeneous distribution of binding forces between the backside of the carrier mesh and the backing layer is the result of a homogenous distribution of ions enabling the formation of covalent bonds between the backside of the carrier mesh and the backing layer, wherein preferably the homogeneous distribution of binding forces between the backside of the carrier mesh and the backing layer is preferably the result of a homogeneous distribution of ions enabling the formation of covalent bonds between the backside of the carrier mesh and the backing layer and/or providing a cleaning process of the backside of the carrier mesh and/or enhancing the formation of van der Wahl forces between the backside of the carrier mesh and the backing layer.

Clause 41. The artificial turf of any one of clause 39 or 40, wherein a tuft binding force is determined by pre-processing the artificial turf according to DIN EN 13744 and then determining the tuft withdrawal force according to FIFA Test Method 26, whereby the tuft binding force is at least 40 N, in particular at least 50 N.

Clause 42. The artificial turf of any one of clauses 39, 40, and, 41, wherein a tuft binding force of the artificial turf is over 50 N, as determined by a tuft withdrawal force according to FIFA Test Method 26 as specified by FIFA Quality Programme for Football Turf, Handbook of Test Methods, October 2015 Edition.

Clause 43. A method of manufacturing an artificial turf, comprising:
moving a carrier (960) through an air gap (405) formed between a first electrode (602, 604, 402) and a second electrode (404) of a dielectric barrier discharge device (112);
applying a dielectric barrier discharge to one side of the carrier for plasma-activating the side; and
using the plasma-activated carrier for manufacturing the artificial turf.

Clause 44. An artificial turf, comprising:
artificial turf fibers;
a carrier mesh including a backside, wherein the artificial turf fibers are tufted to the carrier mesh, wherein a portion of the artificial turf fibers are exposed on the backside; and
a polyurethane layer coating the backside of the carrier mesh, the polyurethane layer securing the portion of the artificial turf fibers to the carrier mesh, wherein the polyurethane layer is formed from a polyol component and a isocyanate component, wherein the polyurethane layer comprises a filler between 215 and 300 parts per weight for every 100 parts per weight of the polyol component, wherein the artificial turf fibers have a tuft withdrawal force greater than or equal to 40 N.

Clause 45. The artificial turf of clause 44, wherein the polyurethane layer comprises the filler between 220 and 260 parts per weight for every 100 parts per weight of the polyol component, wherein the polyurethane layer preferably comprises the filler between 230 and 260 parts per weight for every 100 parts per weight of the polyol component, and wherein the polyurethane layer more preferably comprises the filler between 240 and 260 parts per weight for every 100 parts per weight of the polyol component.

Clause 46. The artificial turf of clause 44 or 45, wherein the filler comprises any one of the following: calcium carbonate, coal-fly-ash, aluminum tri hydrate (ATH), Magnesium Oxide, and combinations thereof, and wherein the filler preferably comprises or consists of calcium carbonate.

Clause 47. The artificial turf of clause 44, 45, or 46, wherein the polyol component comprises any one of the following: a mixture of a polypropylene glycol diol and a short chain difunctional glycol and a polyol mixture with primary and secondary OH-functional, and wherein the polyol component preferably comprises or consists of a mixture of a polypropylene glycol diol and a short chain difunctional glycol.

Clause 48. The artificial turf of any one of clauses 44 through 47, wherein the isocyanate component comprises any one of the following: low functionality polymeric MDI, Methylene diphenyl diisocyanate (MDI), Toluol-Diisocyanate (TDI), Hexamethylenediisocyanate (HMDI), and Isophorone diisocyanate (IPDI), and wherein the isocyanate component preferably comprises or consists of low functionality polymeric MDI.

Clause 49. The artificial turf of any one of clauses 44 through 48, wherein the polyurethane layer comprises plasma-discharge enhanced covalent bonds and/or plasma-discharge enhanced van der Wahl bonding to the backside and to the artificial turf fibers.

Clause 50. The artificial turf of any one of clauses 44 through 49, wherein the polyurethane layer was applied to the backside of the carrier mesh after plasma-based activation of the backside and the portion of the artificial turf fibers with a dielectric barrier discharge.

Clause 51. The artificial turf of clause 50, wherein the backside and the portion of the artificial turf fibers were plasma-activated with the dielectric barrier discharge multiple times.

Clause 52. The artificial turf of any one of clauses 44 through 51, wherein the tuft withdrawal force is greater than or equal to 40 N when the artificial turf is dry.

Clause 53. The artificial turf of any one of clauses 44 through 52, wherein the tuft withdrawal force is greater than or equal to 40 N after soaking the artificial turf in water for between three and six hours, wherein in particular the tuft withdrawal force is greater than or equal to 40 N after soaking the artificial turf in 70° C. water for two weeks.

Clause 54. The artificial turf of any one of clauses 44 through 53, wherein the polyurethane layer comprises a drying agent, and wherein the drying agent is preferably zeolite

Clause 55. The artificial turf of any one of clauses 44 through 54, wherein the tuft withdrawal force is determined by pre-processing the artificial turf according to DIN EN 13744 and then determining the tuft withdrawal force according to FIFA Test Method 26, whereby the tuft binding force is at least 40 N, in particular at least 50 N.

Clause 56. The artificial turf any one of clauses 44 through 55, wherein a tuft binding force of the artificial turf is over 40 N, as determined by a tuft withdrawal force according to FIFA Test Method 26 as specified by FIFA Quality Programme for Football Turf, Handbook of Test Methods, October 2015 Edition.

Clause 57. The artificial turf of any one of clauses 44 through 56, wherein the artificial turf fibers comprise monofilaments, wherein the monofilaments comprise:
at least one polymer (204); and
a nucleating agent (202, 302) for crystallizing the at least one polymer, the nucleating agent being an inorganic and/or an organic substance or a mixture thereof,
wherein the inorganic nucleating agent consists of one or more of the following:
talcum;
kaolin;
calcium carbonate;
magnesium carbonate;
silicate;
silicic acid;
silicic acid ester;
aluminium trihydrate;
magnesium hydroxide;
meta- and/or polyphosphate; and
coal fly ash;
wherein the organic nucleating agent consists of one or more of the following:
1,2-cyclohexane dicarbonic acid salt;
benzoic acid;
benzoic acid salt;
sorbic acid; and
sorbic acid salt;
wherein the artificial turf fibers are arranged such that first parts of the monofilaments of the arranged artificial turf fibers are exposed to a bottom side of the carrier and second parts of said monofilaments are exposed to a top side of the carrier and wherein at least the first parts are embedded in and mechanically fixed by the polyurethane layer.

Clause 58. An artificial turf, comprising:
artificial turf fibers;
a carrier mesh including a backside, wherein the artificial turf fibers are tufted to the carrier mesh, wherein a portion of the artificial turf fibers are exposed on the backside; and
a polyurethane layer coating the backside of the carrier mesh, the polyurethane layer securing the portion of the artificial turf fibers to the carrier mesh, wherein the polyurethane layer is formed from a polyol component and a isocyanate component, wherein the polyurethane layer comprises a filler above or equal to 150 and below 215 parts per weight for every 100 parts per weight of the polyol component, wherein the artificial turf fibers have a tuft withdrawal force greater than or equal to 50 N.

Clause 59. The artificial turf of clause 58, wherein the polyurethane layer comprises the filler between 200 and below 215 parts per weight for every 100 parts per weight of the polyol component, wherein the polyurethane layer preferably comprises the filler between 200 and below 210 parts per weight for every 100 parts per weight of the polyol component, and wherein the wherein the artificial turf fibers have the tuft withdrawal force greater than or equal to 55 N.

Clause 60. The artificial turf of clause 58 or 59, wherein the filler comprises any one of the following: calcium carbonate, coal-fly-ash, aluminum tri hydrate (ATH), Magnesium Oxide, and combinations thereof, and wherein the filler preferably comprises or consists of calcium carbonate.

Clause 61. The artificial turf of clause 58, 59, or 60, wherein the polyol component comprises any one of the following: a mixture of a polypropylene glycol diol and a short chain difunctional glycol and a polyol mixture with primary and secondary OH-functional, and wherein the polyol component preferably comprises or consists of a mixture of a polypropylene glycol diol and a short chain difunctional glycol.

Clause 62. The artificial turf of any one of clauses 58 through 61, wherein the isocyanate component comprises wherein the isocyanate component comprises any one of the following: low functionality polymeric MDI, Methylene diphenyl diisocyanate (MDI), Toluol-Diisocyanate (TDI), Hexamethylenediisocyanate (HMDI), and Isophorone diisocyanate (IPDI), and wherein the isocyanate component preferably comprises or consists of low functionality polymeric MDI.

Clause 63. The artificial turf of any one of any one of clauses 58 through 62, wherein the polyurethane layer comprises plasma-discharge enhanced covalent bonds and/or plasma-discharge enhanced van der Wahl bonding to the backside and to the artificial turf fibers.

Clause 64. The artificial turf of any one of clauses 58 through 63, wherein the polyurethane layer was applied to the backside of the carrier mesh after plasma-based activation of the backside and the portion of the artificial turf fibers with a dielectric barrier discharge.

Clause 65. The artificial turf of any one of clauses 58 through 64, wherein the backside and the portion of the artificial turf fibers were plasma-activated with the dielectric barrier discharge multiple times.

Clause 66. The artificial turf of any one of clauses 58 through 65, wherein the tuft withdrawal force is greater than or equal to 40 N when the artificial turf is dry.

Clause 67. The artificial turf of any one of any one of clauses 58 through 66, wherein the tuft withdrawal force is greater than or equal to 40 N after soaking the artificial turf in water for between three and six hours, wherein in particular the tuft withdrawal force is greater than or equal to 40 N after soaking the artificial turf in 70° C. water for two weeks.

Clause 68. The artificial turf of any one of clauses 58 through 67, wherein the polyurethane layer comprises a drying agent, and wherein the drying agent is preferably zeolite.

Clause 69. The artificial turf of any one of clauses 58 through 68, wherein the tuft withdrawal force is determined by pre-processing the artificial turf according to DIN EN 13744 and then determining the tuft withdrawal force according to FIFA Test Method 26, whereby the tuft binding force is at least 40 N, in particular at least 50 N.

Clause 70. The artificial turf any one of clauses 58 through 69, wherein a tuft binding force of the artificial turf is over 40 N, as determined by a tuft withdrawal force according to FIFA Test Method 26 as specified by FIFA Quality Programme for Football Turf, Handbook of Test Methods, October 2015 Edition.

Clause 71. The artificial turf of any one of clauses 58 through 70, wherein the artificial turf fibers comprise monofilaments, wherein the monofilaments comprise:
at least one polymer (204); and
a nucleating agent (202, 302) for crystallizing the at least one polymer, the nucleating agent being an inorganic and/or an organic substance or a mixture thereof, wherein the inorganic nucleating agent consists of one or more of the following:
talcum;
kaolin;
calcium carbonate;
magnesium carbonate;
silicate;
silicic acid;
silicic acid ester;
aluminium trihydrate;
magnesium hydroxide;
meta- and/or polyphosphate; and
coal fly ash;
wherein the organic nucleating agent consists of one or more of the following:
1,2-cyclohexane dicarbonic acid salt;
benzoic acid;
benzoic acid salt;
sorbic acid; and
sorbic acid salt;
wherein the artificial turf fibers are arranged such that first parts of the monofilaments of the arranged artificial turf fibers are exposed to a bottom side of the carrier and second parts of said monofilaments are exposed to a top side of the carrier and wherein at least the first parts are embedded in and mechanically fixed by the polyurethane layer.

1. An artificial turf, comprising:
artificial turf fibers;
a carrier mesh including a backside, wherein the artificial turf fibers are tufted to the carrier mesh, wherein a portion of the artificial turf fibers are exposed on the backside; and
a polyurethane layer coating the backside of the carrier mesh, the polyurethane layer securing the portion of the artificial turf fibers to the carrier mesh, wherein the polyurethane layer is formed from a polyol component and a isocyanate component, wherein the polyurethane layer comprises a filler above or equal to 150 and below 215 parts per weight for every 100 parts per weight of the polyol component, wherein the artificial turf fibers have a tuft withdrawal force greater than or equal to 50 N, wherein the artificial turf fibers preferably have a tuft withdrawal force greater than or equal to 51N.

2. The artificial turf of claim 1, wherein the polyurethane layer comprises the filler between 200 and below 215 parts per weight for every 100 parts per weight of the polyol component, wherein the polyurethane layer preferably comprises the filler between 200 and below 210 parts per weight for every 100 parts per weight of the polyol component, wherein the wherein the artificial turf fibers have the tuft withdrawal force greater than or equal to 55 N, wherein the wherein the artificial turf fibers have the tuft withdrawal force greater than or equal to 56 N.

3. The artificial turf of claim 1, wherein the filler comprises any one of the following: calcium carbonate, coal-fly-ash, aluminum tri hydrate (ATH), Magnesium Oxide, and combinations thereof, and wherein the filler preferably comprises or consists of calcium carbonate.

4. The artificial turf of claim 1, wherein the polyol component comprises any one of the following: a mixture of a polypropylene glycol diol and a short chain difunctional glycol and a polyol mixture with primary and secondary OH-functional, and wherein the polyol component preferably comprises or consists of a mixture of a polypropylene glycol diol and a short chain difunctional glycol.

5. The artificial turf of claim 1, wherein the isocyanate component comprises wherein the isocyanate component comprises any one of the following: low functionality polymeric MDI, Methylene diphenyl diisocyanate (MDI), Toluol-Diisocyanate (TDI), Hexamethylenediisocyanate (HMDI), and Isophorone diisocyanate (IPDI), and wherein the isocyanate component preferably comprises or consists of low functionality polymeric MDI.

6. The artificial turf of claim 1, wherein the polyurethane layer comprises plasma-discharge enhanced covalent bonds and/or plasma-discharge enhanced van der Wahl bonding to the backside and to the artificial turf fibers.

7. The artificial turf of claim 1, wherein the polyurethane layer was applied to the backside of the carrier mesh after plasma-based activation of the backside and the portion of the artificial turf fibers with a dielectric barrier discharge.

8. The artificial turf of claim 7, wherein the backside and the portion of the artificial turf fibers were plasma-activated with the dielectric barrier discharge multiple times.

9. The artificial turf of claim 1, wherein the tuft withdrawal force is greater than or equal to 40 N when the artificial turf is dry, and wherein the tuft withdrawal force is preferably greater than or equal to 41 N when the artificial turf is dry.

10. The artificial turf of claim 1, wherein the tuft withdrawal force is greater than or equal to 40 N after soaking the artificial turf in water for between three and six hours, wherein in particular the tuft withdrawal force is greater than or equal to 40 N after soaking the artificial turf in 70° C. water for two weeks, wherein the tuft withdrawal force is preferably greater than or equal to 41 N after soaking the artificial turf in water for between three and six hours, and wherein in particular the tuft withdrawal force is preferably greater than or equal to 41 N after soaking the artificial turf in 70° C. water for two weeks.

11. The artificial turf of claim 1, wherein the polyurethane layer comprises a drying agent, and wherein the drying agent is preferably zeolite.

12. The artificial turf of claim 1, wherein the tuft withdrawal force is determined by pre-processing the artificial turf according to DIN EN 13744 and then determining the tuft withdrawal force according to FIFA Test Method 26, whereby the tuft binding force is at least 40 N, in particular at least 50 N, and preferably at least 51 N.

13. The artificial turf of claim 1, wherein a tuft binding force of the artificial turf is over 40 N, as determined by a tuft withdrawal force according to FIFA Test Method 26 as specified by FIFA Quality Programme for Football Turf, Handbook of Test Methods, October 2015 Edition, and wherein the tuft binding force of the artificial turf is preferable over 41 N, as determined by a tuft withdrawal force according to FIFA Test Method 26 as specified by FIFA Quality Programme for Football Turf, Handbook of Test Methods, October 2015 Edition.

14. The artificial turf of claim 1, wherein the artificial turf fibers comprise monofilaments, wherein the monofilaments comprise:
at least one polymer (204); and
a nucleating agent (202, 302) for crystallizing the at least one polymer, the nucleating agent being an inorganic and/or an organic substance or a mixture thereof,
wherein the inorganic nucleating agent consists of one or more of the following:
talcum;
kaolin;
calcium carbonate;
magnesium carbonate;
silicate;
silicic acid;
silicic acid ester;
aluminium trihydrate;
magnesium hydroxide;
meta- and/or polyphosphate; and
coal fly ash;
wherein the organic nucleating agent consists of one or more of the following:
1,2-cyclohexane dicarbonic acid salt;
benzoic acid;
benzoic acid salt;
sorbic acid; and
sorbic acid salt;
wherein the artificial turf fibers are arranged such that first parts of the monofilaments of the arranged artificial turf fibers are exposed to a bottom side of the carrier and second parts of said monofilaments are exposed to a top side of the carrier and wherein at least the first parts are embedded in and mechanically fixed by the polyurethane layer.
